(19) United States
(12) Patent Application Publication
(10) Pub. No.: US 2002/0049508 A1
(43) Pub. Date: Apr. 25, 2002

(54) Systems and methods for providing a virtual match of golf

(76) Inventor: Jack L. Williams, Miami, FL (US)

Correspondence Address: FISH & NEAVE, 1251 AVENUE OF THE AMERICAS, 50TH FLOOR, NEW YORK, NY, 10020-1105, US

(21) Appl. No.: 09/854,003

(22) Filed: May 11, 2001

Related U.S. Application Data
(60) Provisional application No. 60/242,943, filed on Oct. 24, 2000.
(60) Provisional application No. 60/264,438, filed on Jan. 26, 2001.

(51) Int. Cl. G06F 155/00

(52) U.S. Cl. 700/92

(57) ABSTRACT

A virtual scorecard is presented that allows at least two players or any number of teams of players to compete in a golf match on different days and from different golf courses. A first player challenges at least a second player with a competitive format and time limit within which play must be concluded and scores submitted. Each player plays a round of golf and enters their score, including handicap, on an on-line system. The system creates a virtual scorecard using the net scores based on handicaps and slope ratings. The same handicap holes from each player's scorecard are paired up as the same hole on the virtual scorecard. Based on the competitive format selected (match play, stroke play, or stableford play), scores are tallied and a winner is determined. Various tools are also provided for tracking performance of golfers, gathering golf-related information and instruction and communicating with other golfers.

### CROSS REFERENCE TO RELATED APPLICATION

This claims the benefit of U.S. Provisional Patent Application No. 60/242,943, filed Oct. 24, 2000, and U.S. Provisional Patent Application No. 60/264,438, filed Jan. 26, 2001.

### BACKGROUND OF THE INVENTION

This invention relates to golf. More particularly, this invention relates to systems and methods for providing a virtual match of golf.

Golf's popularity appears to have plateaued, with an annual growth rate of less than 2%. A round of golf typically consists of eighteen holes. At each hole, score is kept by recording onto a scorecard the number of strokes, or swings, that a player (or golfer) takes to hit a golf ball from a tee, or starting point, into a designated hole.

Most major golf courses are rated for difficulty by, for example, in the United States, by the United States Golf Association (USGA). Under the USGA rating system, information is provided on a distance, par, and handicap rating for every hole, and a slope rating and a course rating for every type of tee on each golf course. The distance is measured (typically in yards) from a set of tees to a hole. There are multiple types of tees, or starting points, with different distances from the hole. The type of tees that a player begins from depends on the skill of the player. Par is a value indicating the number of strokes it should take to hit the ball into the hole. This number is typically based on the distance and difficulty of the hole. For most courses, the holes typically range from a par 3 to a par 5, and in some instances, a par 6. The handicap rating is a rating of all eighteen holes for a given golf course by difficulty of the holes. The slope ratings describe an overall level of difficulty for each type of tees on a given golf course. Typically, three or four professional course raters take all obstacles and terrain into account, to derive whole numbers in the range of 100 to 155. The course ratings describe levels of difficulty for each type of tees to a scratch player, typically in the range of 68.0 and 74.9. This value is typically expressed as a decimal to the tenths. For both the slope ratings and the course ratings, the higher the number, the more difficult the course.

A player's performance at a hole may be measured relative to the par for a hole. If the player's score (number of strokes from a tee to a hole) is the same as the par for a given hole, the player is said to have shot a “par.” If the player takes one less stroke than the par, the player has shot a “birdie.” If the player takes two less strokes than the par, the player has shot an “eagle.” If the player takes three less strokes than the par, the player has shot a “double eagle.” It is extremely rare to hit more than three strokes less than par. If the player takes one more swing than the par, the player has shot a “bogey.” If the player takes two more swings than the par, the player has shot a “double bogey.”

Two players or a team of players may compete in a golf match at the same course. There are typically three competitive formats: match play, stroke play, or stableford play. In match play, a winner is determined by the player or team who wins the most number of holes. The winner of each hole is the player or team with the least number of strokes relative to par. In stroke play, the total number of strokes for all eighteen holes are summed. The winner is the player or team with the least number of strokes relative to par. In stableford play, point values are assigned for results at each hole (e.g., 18 points are assigned for a double eagle, +5 points for an eagle, +3 points for a birdie, 0 points for a par, −1 point for a bogey, and −3 points for a double bogey). The winner is the player or team with the most points.

Because players have different golfing abilities, players are assigned handicaps based on their performance. Based on handicaps, scores are adjusted to provide a more fair playing field to allow two players or a teams of players to compete.

There is a standard United States formula for calculating a handicap. First, a handicap differential is calculated by subtracting the USGA course rating of the course played from the adjusted gross score. This subtracted result is then multiplied by “113” and divided by the USGA slope rating of the course played. The adjusted gross score is the total score that a player received on the course (not taking handicap strokes into account). “113” represents the slope of a course of “average” difficulty.

After the handicap differential is computed, the result is then multiplied by 96% (the resulting number is known as a handicap index), which acts as an incentive for players to improve their game. If more than one score is added (from multiple rounds of golf), the differentials are averaged to produce an average differential. The player's official handicap is computed by multiplying the handicap index (rounded to the nearest tenth) with the USGA slope rating of the course played and dividing by “113.” The result is then rounded off to the nearest whole number.

A typical player will have a handicap greater than eighteen. Very skilled players will have a handicap less than 18—but none lower than zero. A handicap deducts a stroke from a player's score at a handicap hole. For example, for a handicap of twenty, a player will receive one stroke on all eighteen holes plus an additional stroke on the first two handicap holes (i.e., handicap holes 1 and 2 will be awarded two strokes). Receiving a stroke means deducting a stroke from a player's adjusted gross score at the specified handicap hole, which results in a net score.

Currently, golfers may only compete fairly by playing on the same golf course at the same time. The winner of a round of golf is determined by implementing the handicaps and comparing each player's performance at each hole from the first hole to the eighteenth hole. However, golfers separated by distance, conflicting schedules, or even by personal preference/accessibility to certain golf courses, are unable to fairly compete in a golf match.

Research has validated that a vast majority of golfers have friends in other cities that they would like to play competitive golf with more frequently, but can't because of physical separation. In other words, the current physical need to be on the same course at the same time to enjoy competitive golf is a direct cause for the stagnation in the number of rounds of golf played annually.

In view of the foregoing, it would be desirable to provide a virtual scorecard that will allow any number of golfers to fairly compete in a golf match when factors exist that prevent the golfers from playing together on the same day at the same course—or when amateur golfers wish to compete against professional golfers.

It would also be desirable to provide various tools to enable golfers to monitor statistics of their golf game and provide information relating to golf and golf services.

### SUMMARY OF THE INVENTION

It is an object of this invention to provide a virtual scorecard that will allow an unlimited number of golfers to fairly compete in a golf match when factors exist that prevent the golfers from playing together on the same day at the same course.

It is also an object of the invention to provide various tools to enable golfers to monitor statistics of their golf game and provide information relating to golf and golf services.

In accordance with this invention, a virtual scorecard is provided to allow any golfer to play any number of other golfers from anywhere at any time. For example, a golfer in Miami may play a golfer in Los Angeles, on different days and from different golf courses.

Using a golf handicap system in conjunction with a course index and slope rating system, a virtual scorecard may be created to integrate separate scorecards from each player or team of players to determine the winner of the golf match. All the players have to do is to enter their scorecards and, once all players', or each team member's, scorecards are in the system, a virtual scorecard may be computed and a winner may be determined based on the competition format (i.e., match play, stroke play, stableford play) agreed upon.

To fairly determine the winner of a match played by two players on different courses, a virtual scorecard matches up each player's score by the same handicap hole. The number one hole on the virtual scorecard is preferably the number one handicap hole off both of the players' scorecards, which may be, for example, the fourth hole for a first player and the sixth hole for a second player. The handicap holes are preferably lined up with the first handicap hole being the first hole on the virtual scorecard through to the eighteenth handicap hole being the eighteenth hole on the virtual scorecard. Thus, players compete on the basis of how they scored on equivalent handicap holes from the courses actually played on, and therefore can see who played their course better on their given handicap.

The present invention may create the virtual scorecard using software to compute the results once all scorecards have been submitted and handicaps have been calculated.

One process of creating a virtual match may involve six steps. First, a player may issue a challenge to any number of opponents, who then have an opportunity to accept or deny the challenge. Second, the players may have a certain number of days to play their respective rounds of golf and to submit their scorecards. Third, the players may enter their scores on-line hole-by-hole. Fourth, the total 18-hole score and the player's handicap may then be calculated. Fifth, whether the player's opponents have already played and submitted one or more scorecards may be determined. If not, a reminder message may be sent to the opponents. Sixth, once all players have entered their scores, the virtual scorecard may be generated and, accounting for the competitive format selected, a winner may be determined.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a hardware implementation in accordance with one embodiment of the present invention;

FIG. 2 illustrates a main menu in accordance with one embodiment of the present invention;

FIG. 3 illustrates a log-in screen in accordance with one embodiment of the present invention;

FIG. 4 illustrates a player setup screen in accordance with one embodiment of the present invention;

FIG. 5 illustrates an account information screen in accordance with one embodiment of the present invention;

FIG. 6 illustrates a starter's shack menu in accordance with one embodiment of the present invention;

FIGS. 7-15 illustrate screen displays of creating a golf match in accordance with one embodiment of the present invention;

FIG. 16 illustrates a scorecard for a first player in accordance with one embodiment of the present invention;

FIG. 17 illustrates a scorecard for a second player in accordance with one embodiment of the present invention;

FIGS. 18-23 illustrate screen displays of the process of submitting a scorecard in accordance with one embodiment of the present invention;

FIGS. 24-30 illustrate displays of generating a virtual scorecard in accordance with one embodiment of the present invention;

FIGS. 31-34 illustrate screen displays of the 19^{th} hole options in accordance with one embodiment of the present invention;

FIGS. 35-42 illustrate screen displays of the “Real World” options available in accordance with one embodiment of the present invention;

FIG. 43 illustrates a flow diagram of a challenge process in accordance with one embodiment of the present invention; and

FIG. 44 illustrates a flow diagram of a scorecard generation process in accordance with one embodiment of the present invention.

### DETAILED DESCRIPTION OF THE INVENTION

The present invention provides systems and methods for scoring a virtual match of golf. This allows two players or a team of players to compete from anywhere at any time.

These systems and methods provide a virtual scorecard which enables unlimited competitors to compete in the same golf match, despite playing on different courses at different times, days or years—and equitably determines the winner of the match—providing an opportunity for all golfers, whether amateur, professional or deceased, to enjoy an actual competitive golf match with the results calculated in the virtual world, as if the players had competed on the same course on the same day at the same time.

Thus, any golfer now has the ability to simulate competitive play in such major and popular professional tournaments as the Masters Tournament, the US Open, the British Open, the PGA Championship or any other professional or amateur tournament. In fact, the invention allows the average golfer for the first time to pursue victory of the Grand Slam Title (winning all four “Majors”), an opportunity prior to this invention reserved only for the professional golfer.

Similarly, every weekend that professional tournaments are played, the invention may determine which professional golfer, regardless of age or gender, played the best round that weekend on their respective course, relative to their own average capabilities.

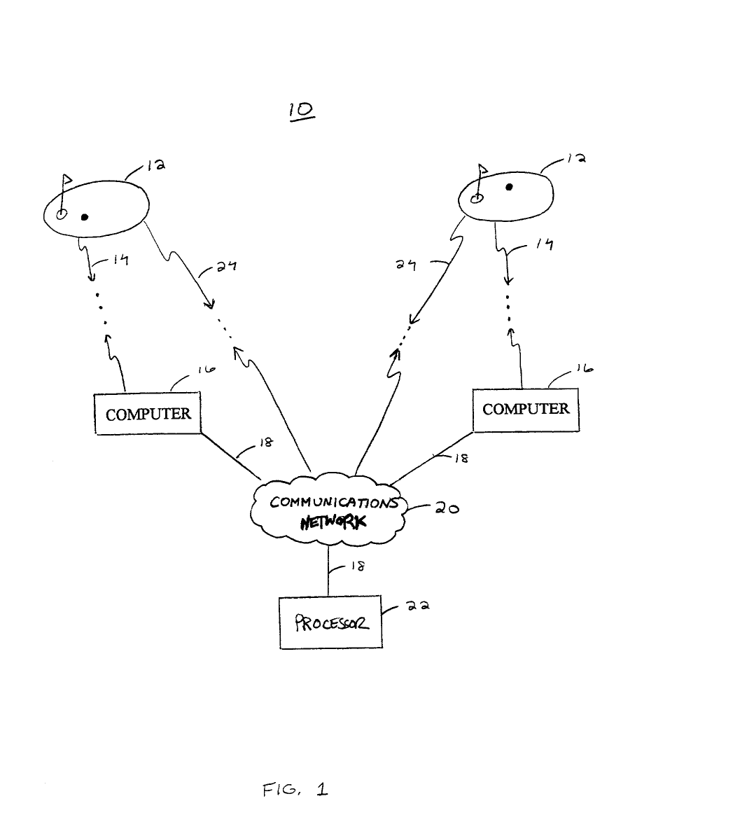

FIG. 1 is a hardware implementation of a system 10 in accordance with one embodiment of the present invention. System 10 may include one or more golf courses 12, one or more computers 16, a communications network 20, and a processor 22.

Two players or a team of players may play on golf courses 12. Golf courses 12 may be the same golf course, different golf courses, or a combination of golf courses (for a team of players). The two players or teams may play at the same time, on the same day, or on different days.

There may be a number of ways for each player to keep track of his or her score. A player may record his performance on a scorecard, on a personal digital assistant (PDA), on a golf-cart based computer system that keeps track of strokes, ball position, etc., on a portable computer that executes a client program and presents an interface to the player, on a wireless phone, on a two-way pager, or using any other suitable approach.

The scoring system on each of golf courses 12 may provide data to processor 22 directly via a communication link 24 and communications network 20. For example, a golf-cart based computer system, a portable computer that executes a client program, or any other suitable system may directly transmit golf data and results from golf course 12 to processor 22 using any suitable communication link 24 and communications network 20, such as a dial-up connection to an internet service provider and the Internet, respectively.

The scoring system on each of golf courses 12 may additionally or alternatively provide data to processor 22 via a communication link 14, computer 16, communication links 18, and a communications network 20. If the scoring system is implemented using a physical scorecard, for example, a player may have to input his or her results into computer 16. If the scoring is implemented using a PDA, as another example, a player may sync his or her results into computer 16. Computer 16 may be a personal computer, a laptop, a web-enhanced television, a web-enabled cellular telephone, or any other suitable device capable of transmitting and receiving web data. Communication link 14 may simply be a player from a golf course physically bringing his or her score to computer 16. Link 14 may also be a wired or wireless medium in which a player can transmit data to computer 16, or may be any other suitable link. Computer 16 may then transmit the golf data and results to processor 22 through communication links 18, and communications network 20.

Communications network 20 may be any suitable data network such as the Internet, an intranet, a local area network, a wide area network, a wireless network, etc.

Processor 22 may be any suitable server or computer, such as a network or Internet server, capable of receiving, storing, and transferring data.

Communication link 18 may be a telephone modem connection, a cable modem connection, a Digital Subscriber Line (DSL) connection, a wireless connection, a direct connection, etc.

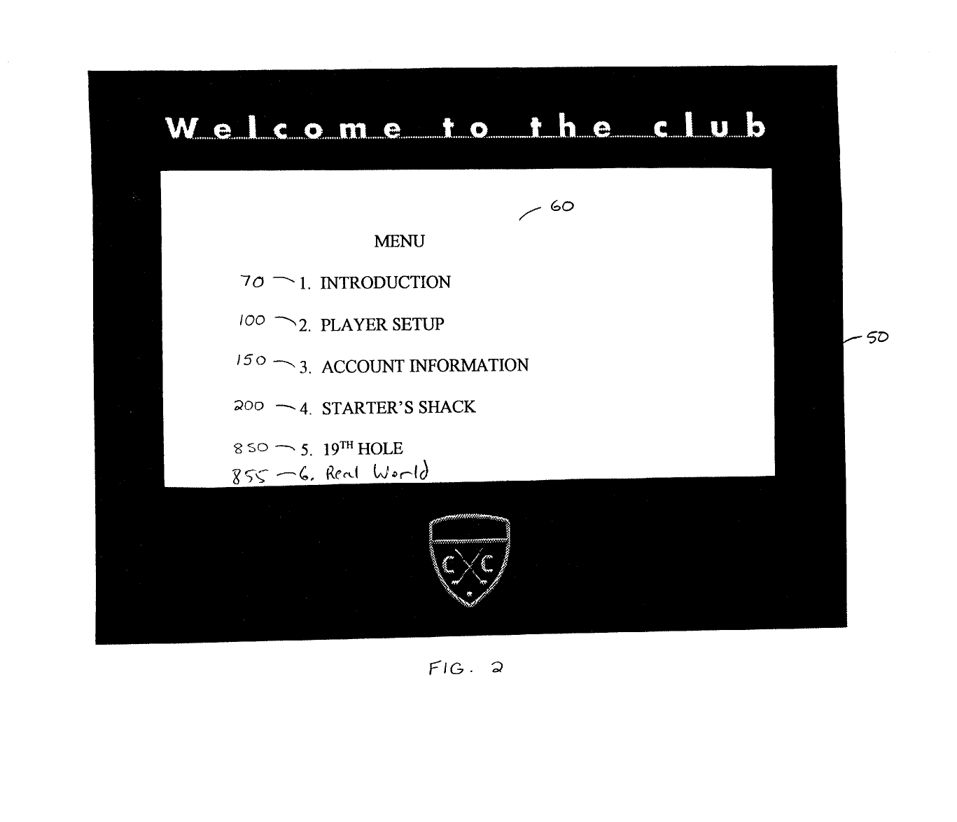

FIG. 2 illustrates a main menu 60 in accordance with one embodiment of the present invention. A display screen 50 with main menu 60 may be displayed on a browser once a user enters, for example, the processor's Universal Resource Locator (URL), or website. Main menu 60 may contain the following options: “1. Introduction” option 70, “2. Player Setup” option 100, “3. Account Information” option 150, “4. Starter's Shack” option 200, “5. 19^{th} Hole” option 850, and “6. Real World” option 855. The main menu selections may be made by selecting the number of the desired option, by moving a highlighted bar to the desired option, using a device such as a keyboard, remote control, mouse, or by using any other suitable approach.

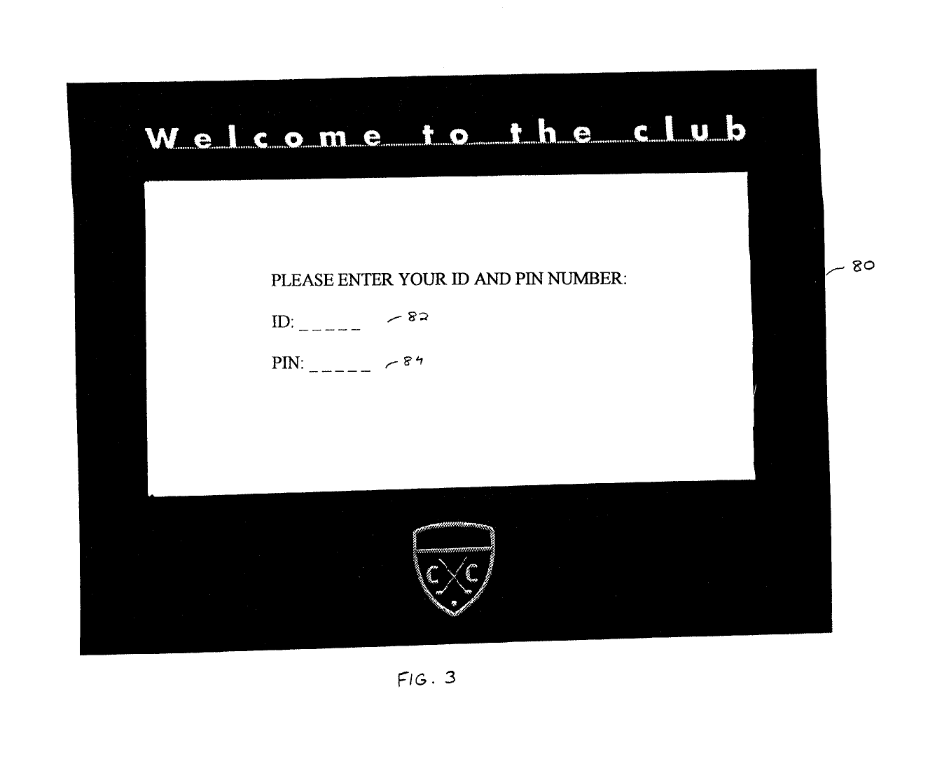

New users or unregistered users may be granted limited access to main menu 60. For example, new users may preferably only be able to select the first two options: “Introduction” option 70 and “Player Setup” option 100. In order to access the other options (“Account Information” option 150, “Starter's Shack” option 200, “19^{th} Hole” option 850, and “Real World” option 855), registered users may have to log-in on a display screen 80 as illustrated in FIG. 3. Each registered user may be assigned, or may choose, a unique identification (ID) 82 and a pin 84. ID 82 and pin 84 may be any combination of numbers and/or letters. Alternatively, user may not be required to register.

Selecting “Introduction” option 70 from main menu 60 (FIG. 2) may provide a user with information about virtual matches. This may include information on what virtual matches are, how a virtual scorecard is created, how a winner is determined, how handicapping works, unique features of the present invention, etc. Also included may be a demonstration of the invention, a glossary of golf terms, and any other suitable information.

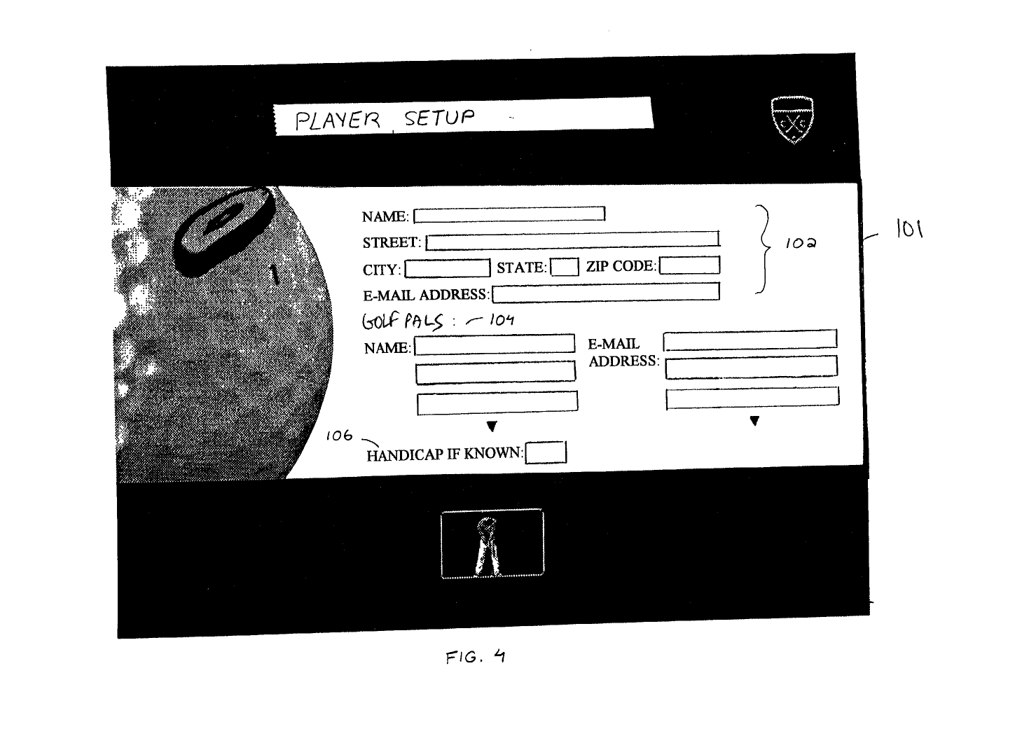

FIG. 4 illustrates a display screen 101 that may be shown when a user selects “Player Setup” 100 from main menu 60 (FIG. 2). New users of the system may register for a virtual match by entering in their demographic information 102 such as name, street address, electronic mail (e-mail) address, etc. To compete with other players, a user may enter in the names and e-mail addresses of his or her golf pals 104. Once entered, these golf pals may then be automatically registered. A user may also enter his or her handicap score 106 if known. Other information that the user may be asked to provide may be to select an ID and pin, a credit card number and an amount to put into his or her personal account, or any other suitable information. Demographic information 102, golf pals 104, handicap 106, and any other relevant information may be updated at any time.

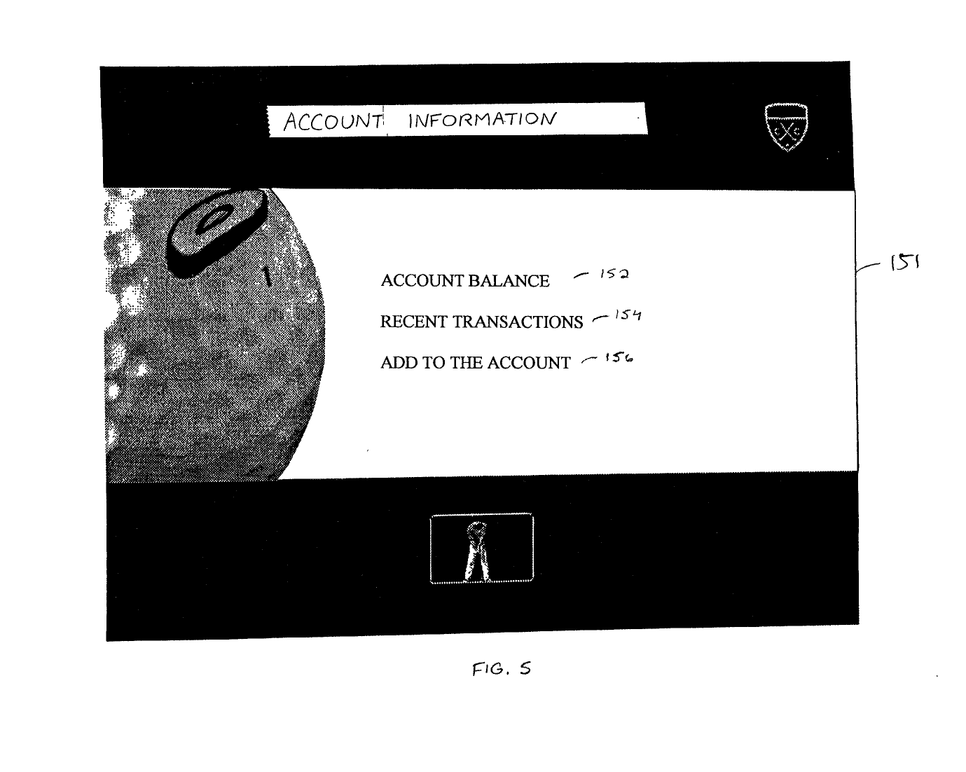

FIG. 5 illustrates a menu display 151 that may be displayed when a player selects “Account Information” 150 from main menu 60 (FIG. 2). A player may select to view “Account Balance” option 152, “Recent Transactions” option 154, or “Add to Account” option 156. “Account Balance” option 152 may show the amount remaining in the player's account. “Recent Transactions” option 154 may list the dates (in ascending or descending order) of the most recent (e.g., last 10, 20, etc.) transactions, including a description of the transaction (e.g., golf game, tournament, proShop purchase, wagering where legal, etc.), amount deducted, and any other relevant information. “Add to Account” option 156 may allow a player to authorize payment using a credit card to place additional money into the player's account.

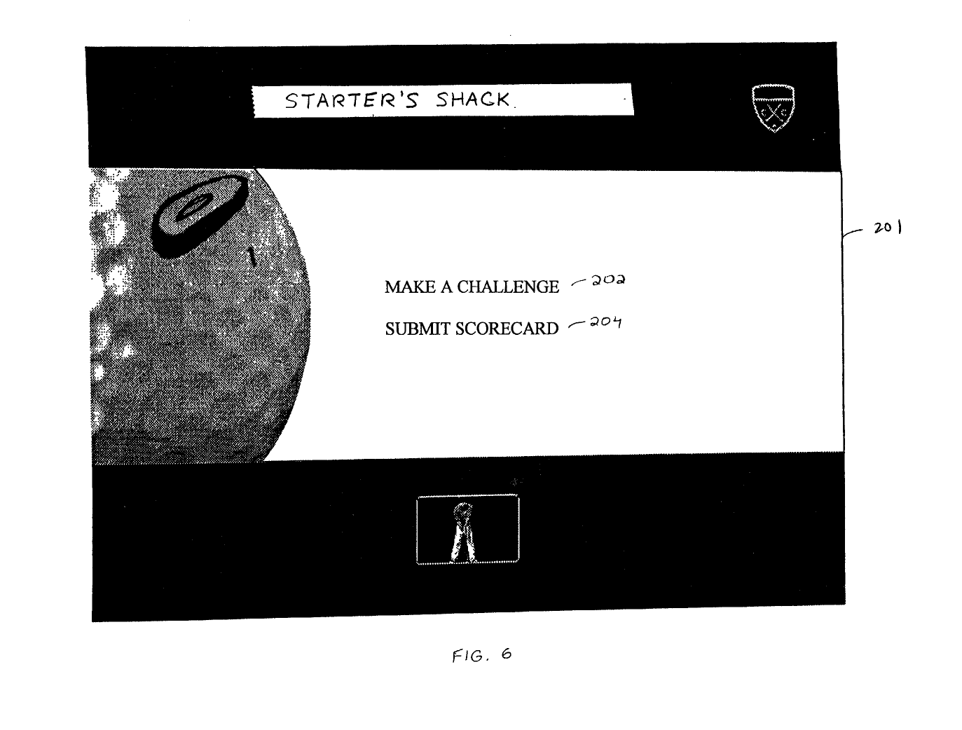

FIG. 6 illustrates a menu display 201 that may be displayed when a player selects “Starter's Shack” 200 from main menu 60 (FIG. 2). A player may select from the following options: “Make a Challenge” option 202 or “Submit Scorecard” option 204. “Make a Challenge” option 202 may allow a player to setup a competition by selecting an opponent or creating two competing teams for a golf match. “Submit Scorecard” option 204 may allow each player to enter results from each player's round of golf.

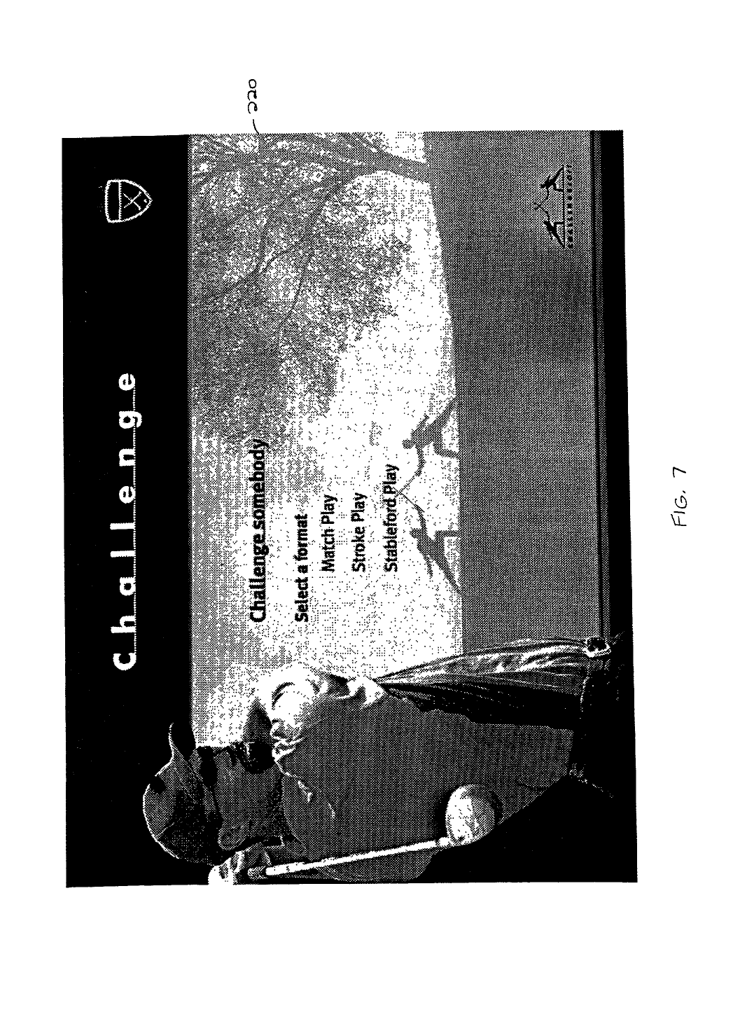

FIGS. 7-15 illustrate screen displays of creating a challenge. As illustrated in FIG. 7, the challenger may have an opportunity to select a competitive format in a display screen 220. The challenger may select one of the following: match play, stroke play, or stableford play. In an alternative embodiment, the opponent may have an opportunity to select the competitive format or the two players may have to agree on a format.

Although not illustrated, the player may have an opportunity to enter a tournament. This tournament may include players who are registered on the system. The tournament may also be an association championship, with players competing with professionals who competed in the actual golf association championship or other professional golf tournaments.

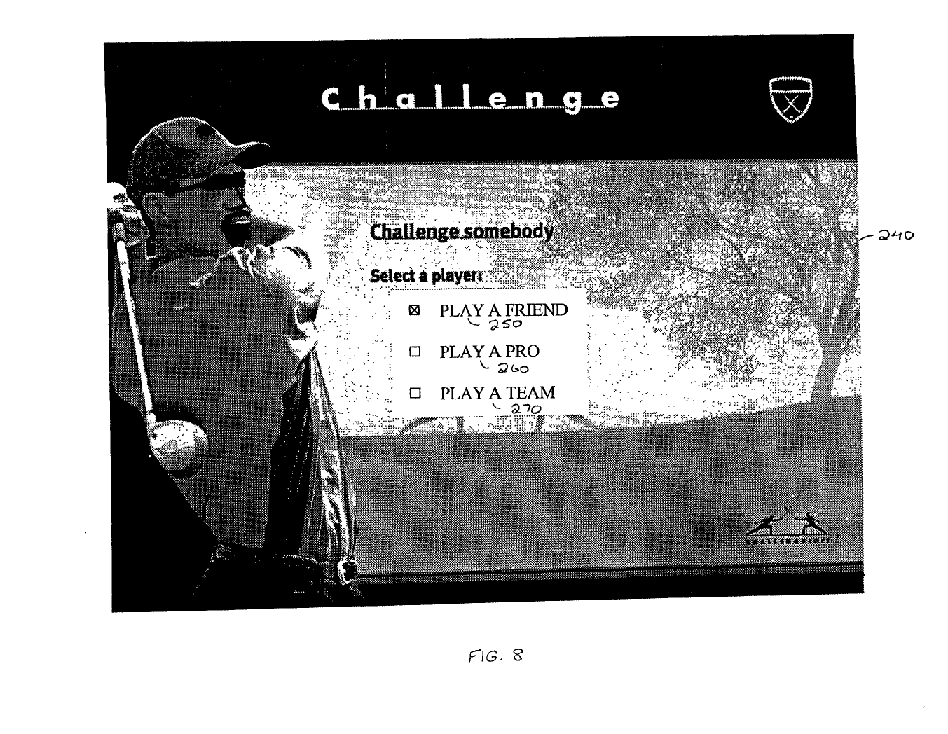

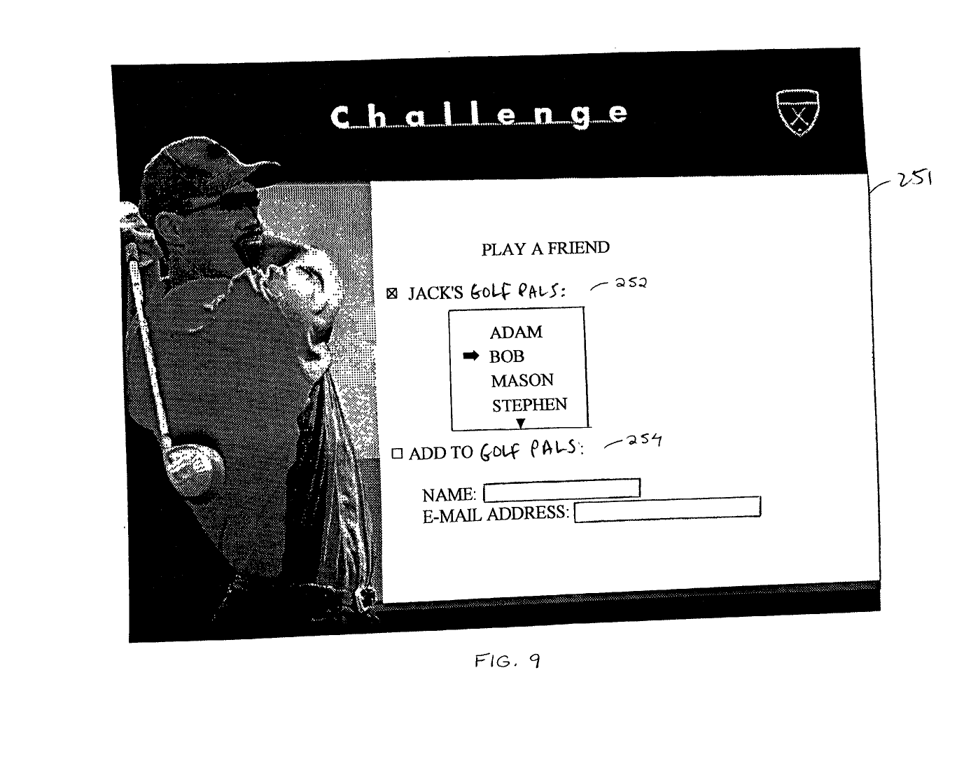

A challenger may have an opportunity to select an opponent in a display screen 240 as illustrated in FIG. 8. The challenger may select to play a friend 250, to play a professional (pro) 260, or to play a team 270. In selecting to play a friend 250, the challenger may select an opponent from his or her personalized golf pals. A display screen of play a friend 251 is illustrated in FIG. 9. The golf pals 252 may include names of people that were added in player setup 101, people who selected the current challenger as an opponent, or people that were later added. There may be a pull-down menu to allow the challenger to select a golf pal. The challenger may even add a new person to the golf pals 254 by entering the person's name and e-mail address.

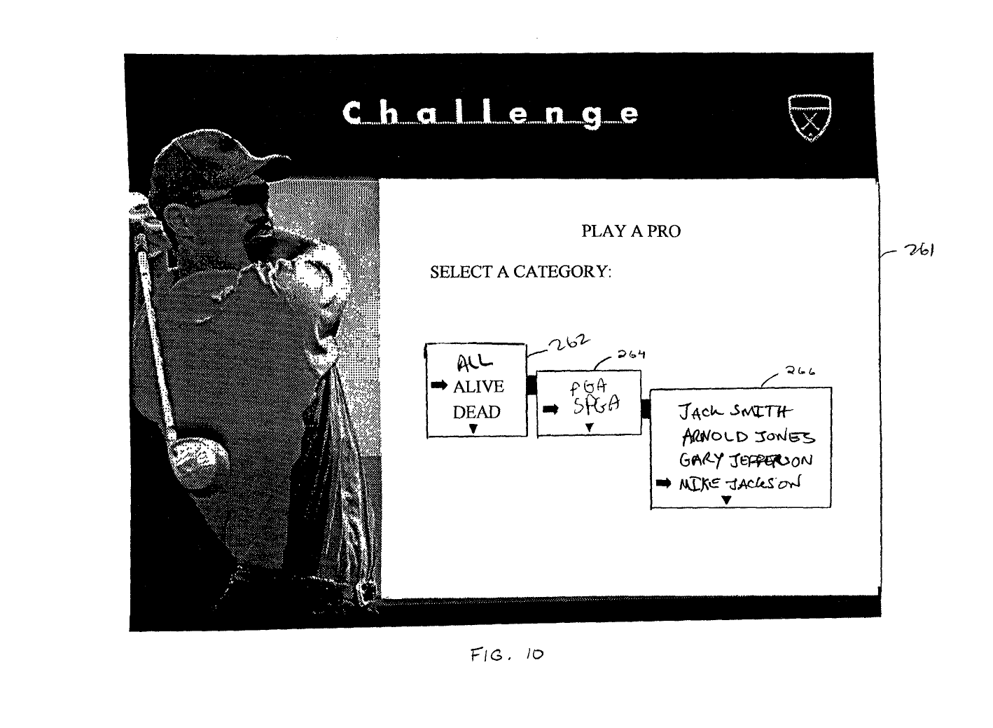

In selecting play a pro 260, the challenger may select his opponent from among a list of professional golfers. A display screen of play a pro 261 is illustrated in FIG. 10. The golfers may be listed in alphabetical order or may be grouped by category 262, such as tour, living golfers, dead golfers, etc. Within the categories may be subcategories 264. For example, in FIG. 10, the challenger may select to play a living pro. The challenger may further select to play a living pro that is part of the SPGA tour. The challenger may select from among a list of living male pro golfers 266 (e.g., Jack Smith, Arnold Jones, Gary Jefferson, Mike Jackson, etc.). Finally, although not shown, the challenger may select a particular round of golf played by the pro from a menu of available rounds, or may select to have a round randomly selected.

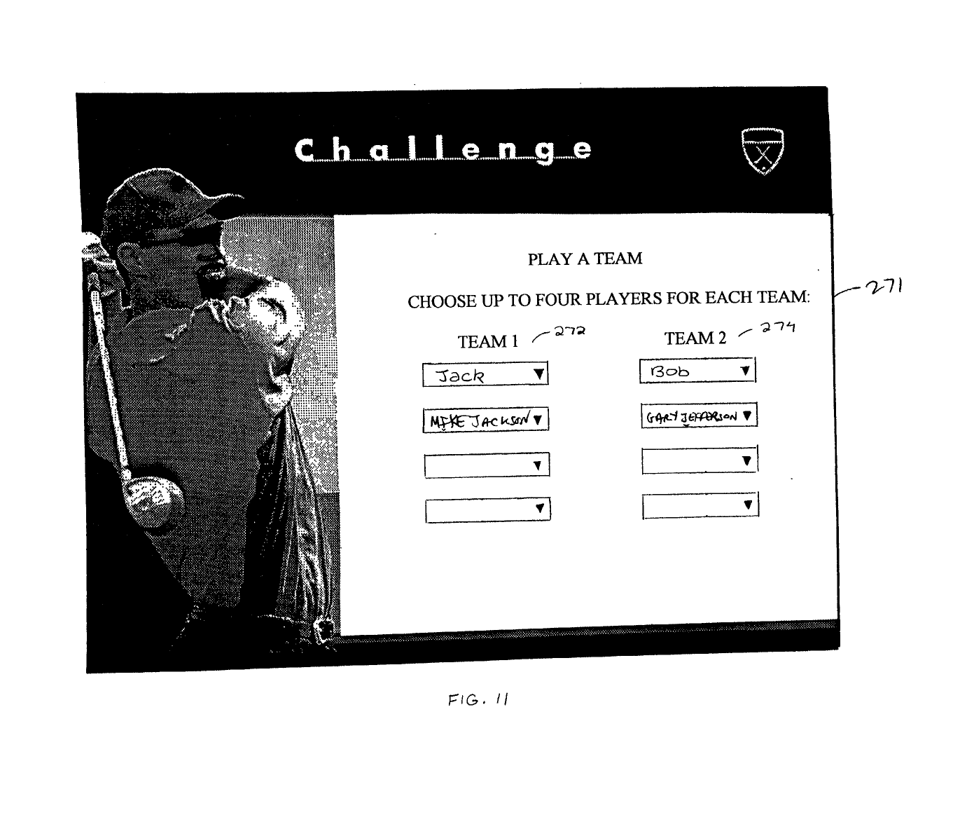

In selecting play a team 270, the challenger may select players to play on his or her own team and players to play on the opposing team. A display screen of play a team 271 is illustrated in FIG. 11. Team 1 272 may include the challenger team and team 2 274 may include the opposing team. The challenger may select any number of players to form a team, preferably selecting the same number of players for each team. Each team may include any combination of players that are male or females, and are professionals or golf pals. In display screen 270, team 1 272 may include the challengers Jack and professional Mike Jackson, while team 2 274 may include Jack's golf pal Bob and professional Gary Jefferson.

In certain embodiments and where legal, a challenger may select a wager amount. This wager amount may be any amount that can legally be wagered on the golf match. Based upon the subsequent outcome of the golf match, this amount (less any applicable commission) may be transferred from the loser's account to the winner's account. Alternatively points could be wagered and prizes awarded when certain point levels are attained.

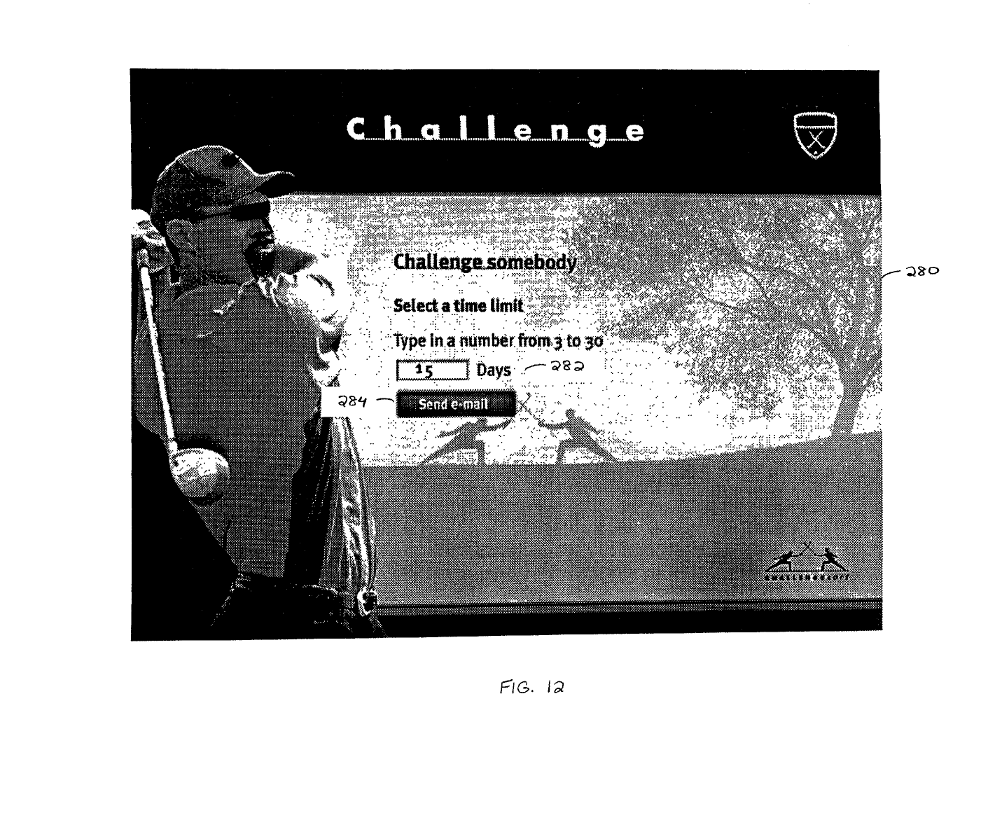

The challenger may then select a time limit 282 in which the challenger(s) and the opponent(s) must play a round a golf and enter their respective scores into the system within a certain number of days. This is illustrated in a display screen 280 in FIG. 12. The time limit may range from three days to thirty days, although any suitable time limit may be used. Once the challenger has entered a valid time limit, the challenger may click “Send e-mail” button 284 to issue the challenge to the selected opponent(s). Button 284 may only be applicable if the challenger selects one or more golf pals to play. If a professional is selected as an opponent, there may be a “Submit” button to enter the selections into the system.

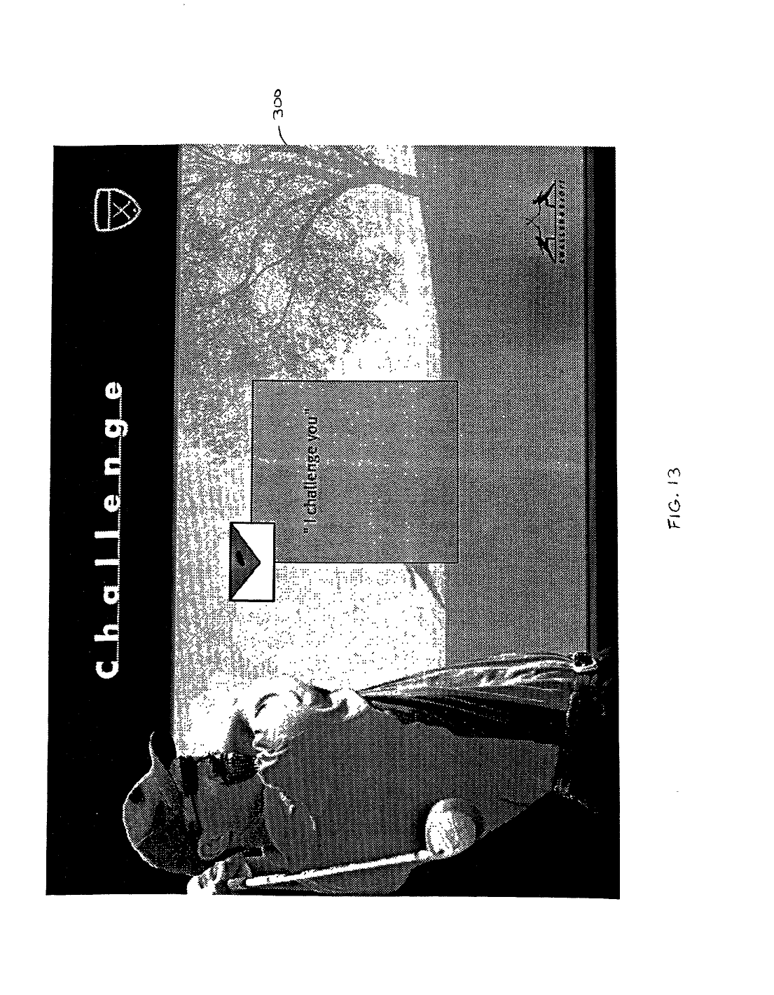

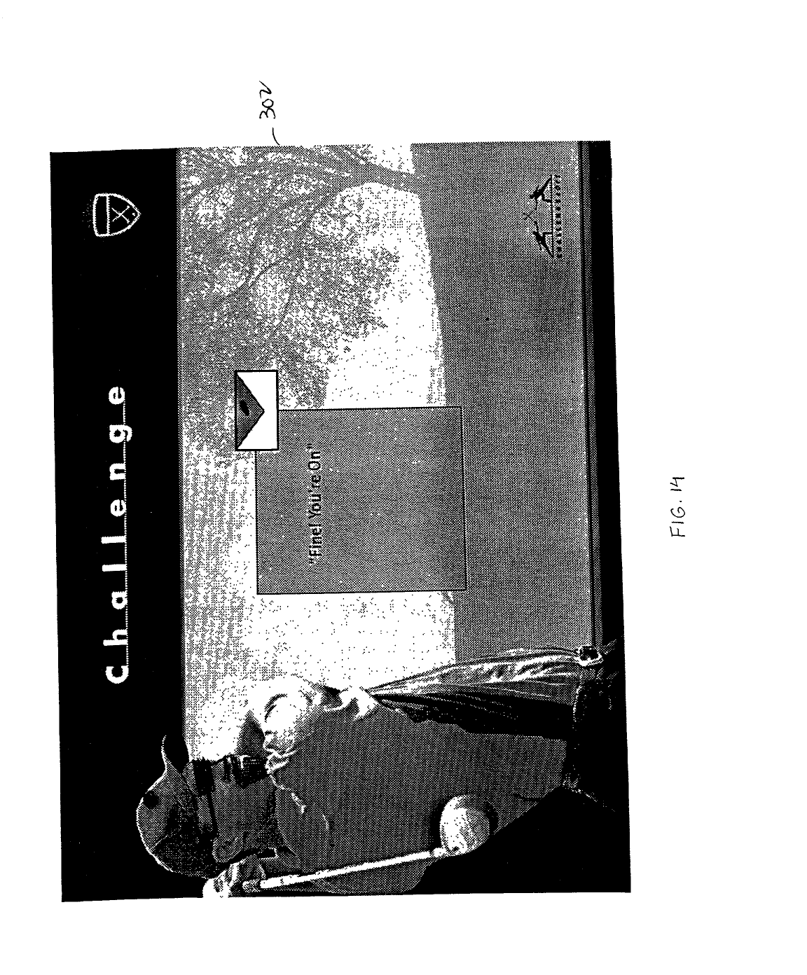

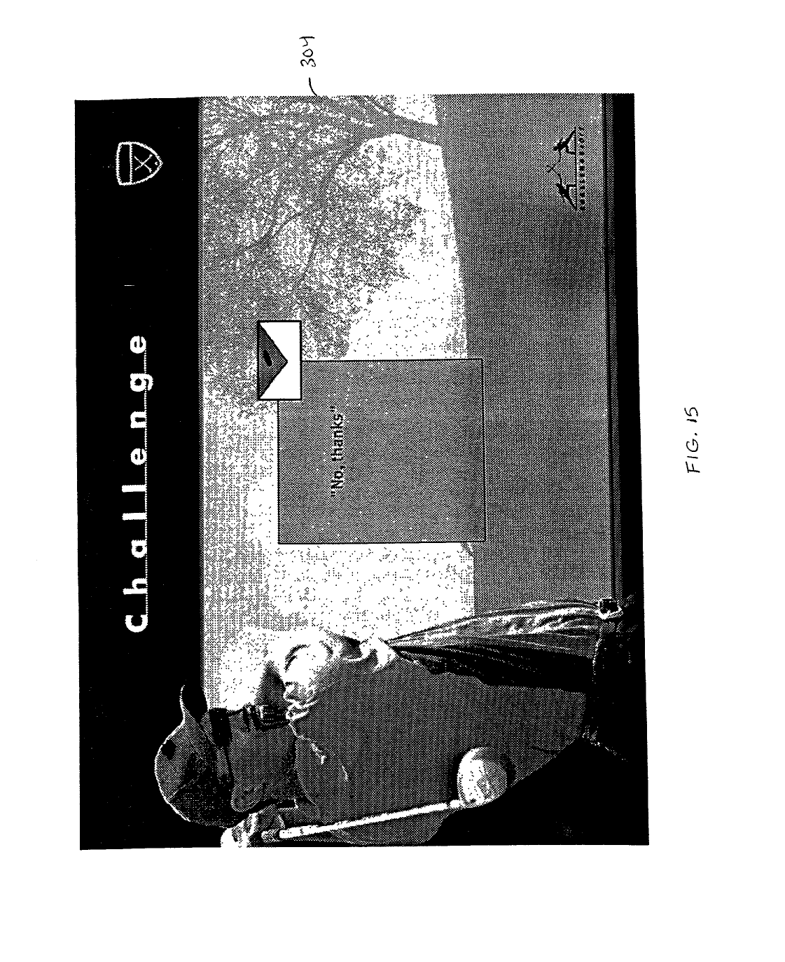

FIGS. 13-15 illustrate sample e-mail messages on a display screens 300, 302, and 304. There may be messages that a challenger can select from to send to his or her golf pals. In addition, there may be responses that a golf pal can select from to send to his or her challenger. As another alternative, the challenger and/or golf pal can send customized messages. Preferably, these messages would not be generated when a challenger is only playing a pro. FIG. 13 shows a sample message 300 from a challenger to his or her golf pal with the phrase “I Challenge You.” Also included in the message, as an attachment, for example, may be information about the challenger, the format selected (i.e., match play, stroke play, or stableford play), the time limit, and any other suitable information. FIG. 14 shows a sample message 302 from a golf pal to his or her challenger accepting the challenge with the phrase “Fine! You're On.” FIG. 15 shows a sample message 304 from a golf pal refusing the challenge with the phrase “No, Thanks.” Although not shown, if a golf pal does not accept the challenge, the challenger may be provided with a menu of insults to send to the golf pal via email as a form of banter for not accepting the challenge.

If the challenge is accepted, a deduction of some dollar amount may be deducted from the challenger's account and each player may then play their respective rounds of golf within the specified time limit.

Each golfer plays an eighteen-hole round of golf. The golfers may play on the same or on a different golf course, and on the same or on a different day. FIG. 16 illustrates a scorecard 350 for a golf course at a country club in Miami, Fla. The top of scorecard 350, which may be applicable to scorecards at most golf courses, may include the hole numbers numbered consecutively from one to eighteen 352, the different starting positions 354, the par 356, the handicap holes 358, and the slope rating 364.

Blue, white, red, and gold 354 may represent the different starting positions for a golfer depending on skill level. For example, for the country club, the blue tee has the longest distance followed by the white, red, and then gold. The blue tee may be for professional male golfers while the gold tee may be for amateurs. The ranking of the tees (e.g., by color) may differ depending on the golf course. The numbers listed under each hole correlating to each color tee can indicate the distance in yards from the respective tee position to the hole.

Par 356 indicates the number of strokes determined by the USGA that it should take to hit a golf ball from a tee to a hole. This number may be based on distance and difficulty of shot. Typically, a golf course has a combination of holes with pars ranging from three to five and in come cases, six.

The men's handicap 358 may indicate the handicap holes from hole one to hole eighteen. The handicap holes may not correlate to the actual hole number (e.g., hole 4 represents handicap hole 1 368, hole 12 represents handicap hole 2 370, . . . , hole 14 represents handicap hole 18 372). The handicap holes may be used in allocating handicap strokes. The challenger's (Jack's) handicap information 362 may be written down or noted on the scorecard. Jack played with a handicap of ten, indicating that a stroke will be deducted from his score on each of the first ten handicap holes. These handicap holes are denoted by an asterisk in handicap row 358.

Jack's adjusted gross score (prior to applying handicap strokes) at each hole 360, may be written down as the course is played. The right most column 366 indicates the total score (e.g., total distance for each tee color, the total score for par, total adjusted gross score for all eighteen holes).

Also included on scorecard 350 may be the slope rating 364, which may be defined as an overall level of difficulty for a course. The slope rating may be a whole number in the range of 100 to 155,

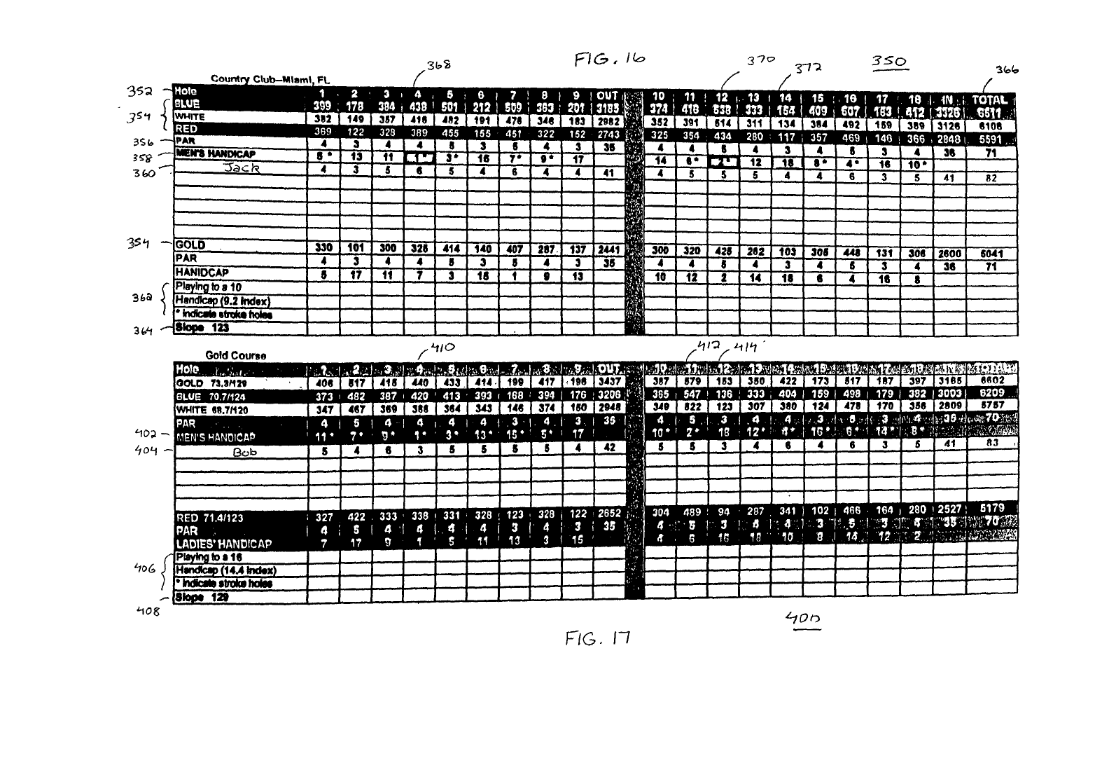

FIG. 17 illustrates a scorecard 400 for a course called the Gold Course. The handicap holes 402 for the Gold Course are listed, which are different from those for the country club as illustrated on scorecard 350 (e.g., hole 4 represents handicap hole 1 410, hole 11 represents handicap hole 2 412, . . . , hole 12 represents handicap hole 18 414). The opponent's handicap information 406 may be written down or noted on the scorecard. Bob played with a handicap of sixteen, indicating that a stroke will be deducted from his score on each of the first sixteen handicap holes. These handicap holes are denoted by an asterisk in handicap row 402. Bob's score at each hole 404 may be written down as the course is played.

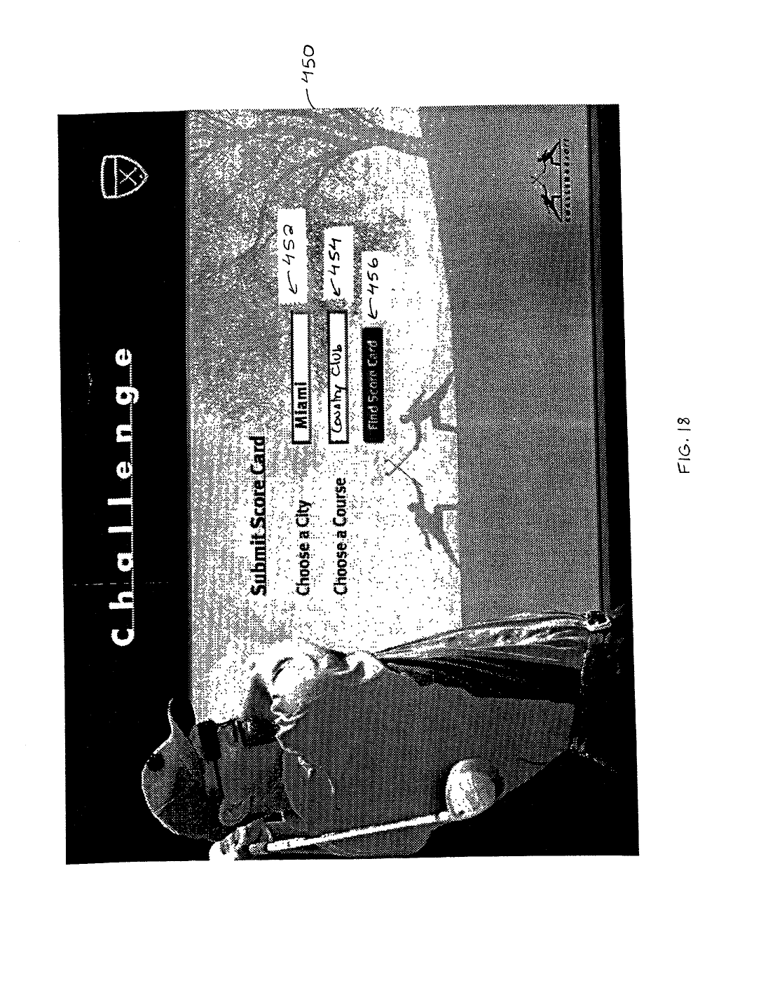

Once a player has played his or her round of golf, the player may log-on to the system and enter the starter's shack (FIG. 6) to select submit scorecard option 204. The player may then be asked if a round of golf has been played. Next, the player may be asked to select the course played on based on the player's home course, the course's input zip code, and/or the name of the course. FIG. 18 illustrates a display screen prompting the player to choose a city 452 and a course 454. The city 452 and course 454 may be selected by typing in the name or selecting the name from a pull-down menu. The player may then select “Find Scorecard” button 456, which may provide an exact replica of the selected scorecard. If a scorecard for the selected city and course is not available, the player may be given a blank scorecard to fill in the details of the course. This information may then be saved so that the next time any registered user enters the selected city and course, a replica of the scorecard may be available.

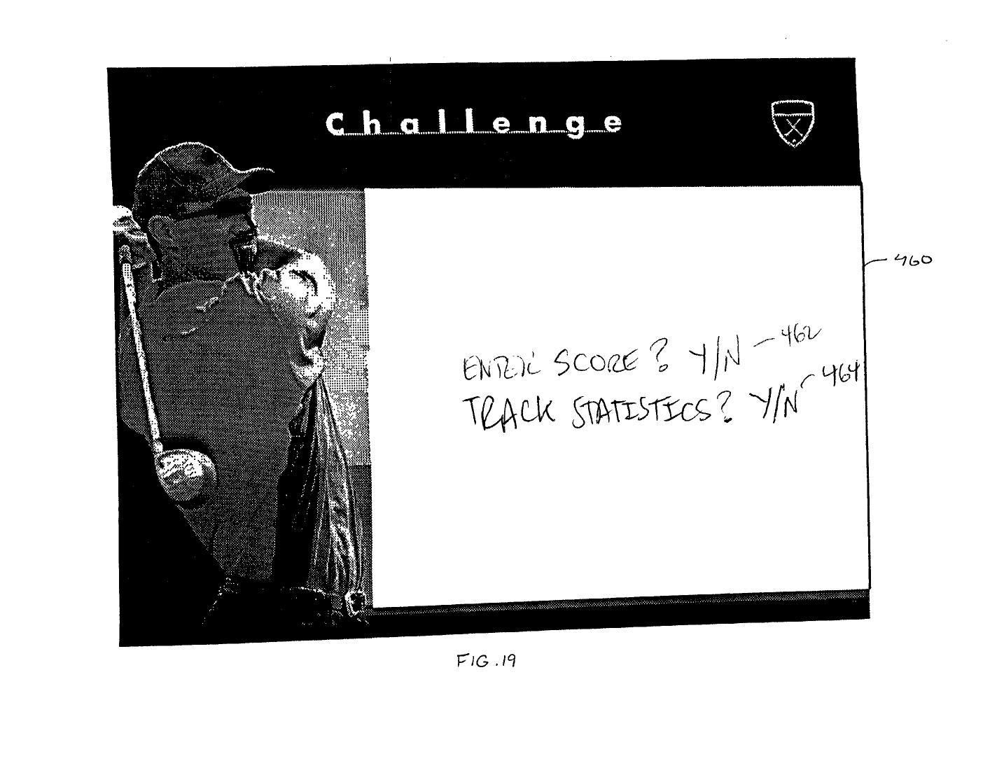

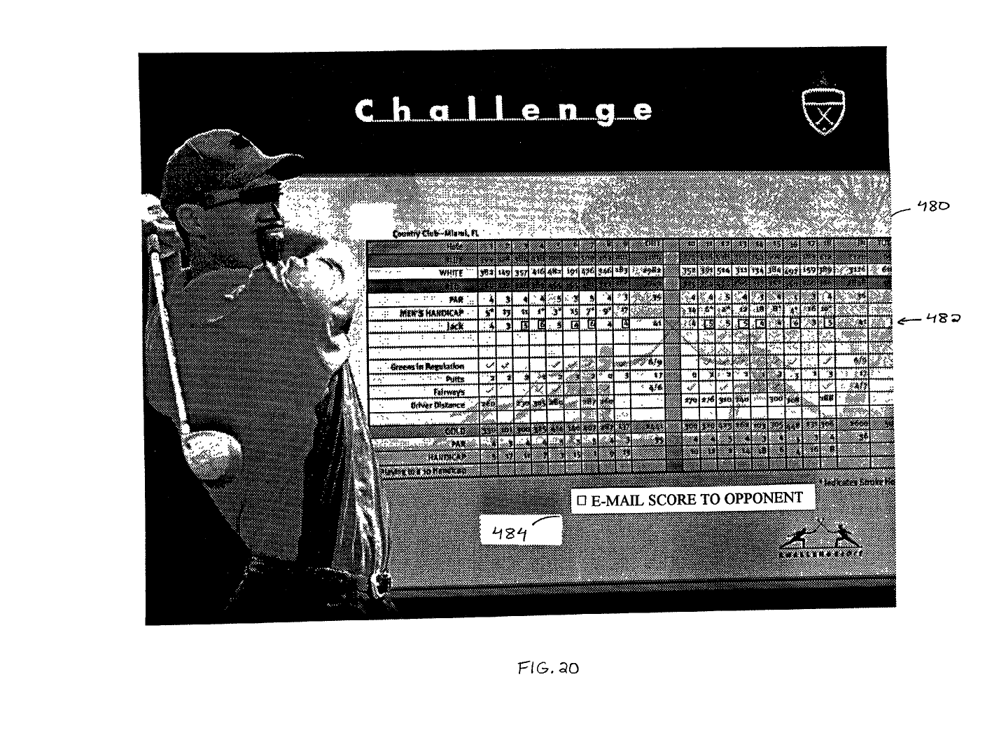

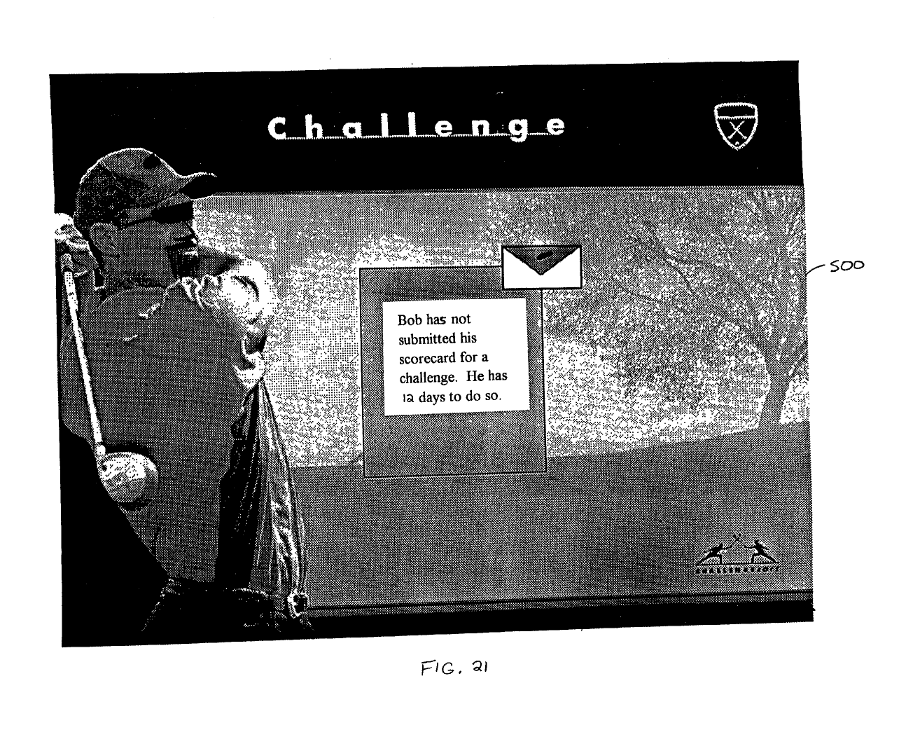

Once the course played has been identified by the system and a replica of the scorecard appears, the player may be able to enter his or her score. FIG. 19 illustrates an option display screen 460 that allows a player to select whether to enter his score 462 and select whether the player wants to track statistics for this round. Once the player has selected to enter his score, the scorecard may be displayed as shown in FIG. 20.

FIG. 20 illustrates a replica 480 of the scorecard for the country club as shown in FIG. 16. Jack may enter his adjusted gross score at each hole for all eighteen holes 482. Once entered, Jack may have an opportunity to e-mail his score to his opponent Bob 484.

The slope of the golf course may be provided on scorecard and may be set by the USGA. Alternatively, any number of individual and course rating systems exist today, or may evolve over time, which may or could be utilized within the invention.

Although not shown, there may be a compute button once the 18^{th} hole score is entered to sum up the eighteen holes for a total score. There may also be other suitable links that allow the player to confirm or change his or her results. The score may then be used to compute and update the handicap. Any suitable method for calculating a handicap may be used in accordance with the present invention. Each player's handicap may be updated prior to matching his or her scorecard against the opponent's scorecard.

The net score is then computed by applying the handicap to the adjusted gross score.

Although not shown, the net score may be based upon additional factors other than handicap if desired. For example, weather conditions may be taken into account if desired. Thus, a player playing in extreme heat, cold, rain, etc. may be provided with a scoring advantage over a player playing in ideal conditions. Any other suitable score modifier could additionally or alternatively be used.

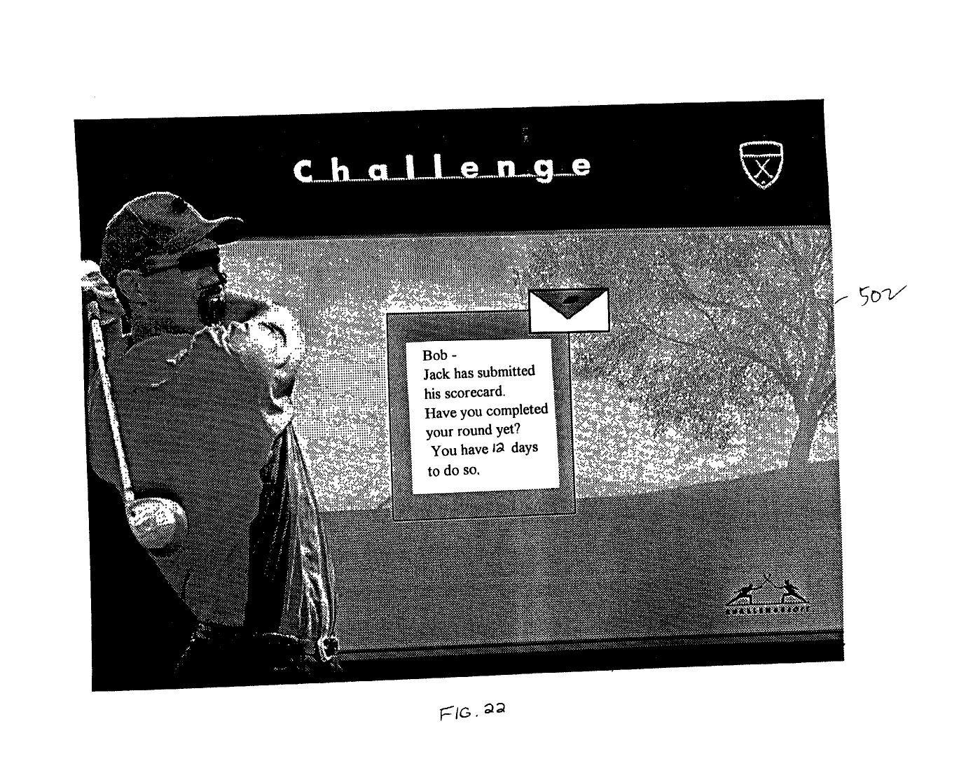

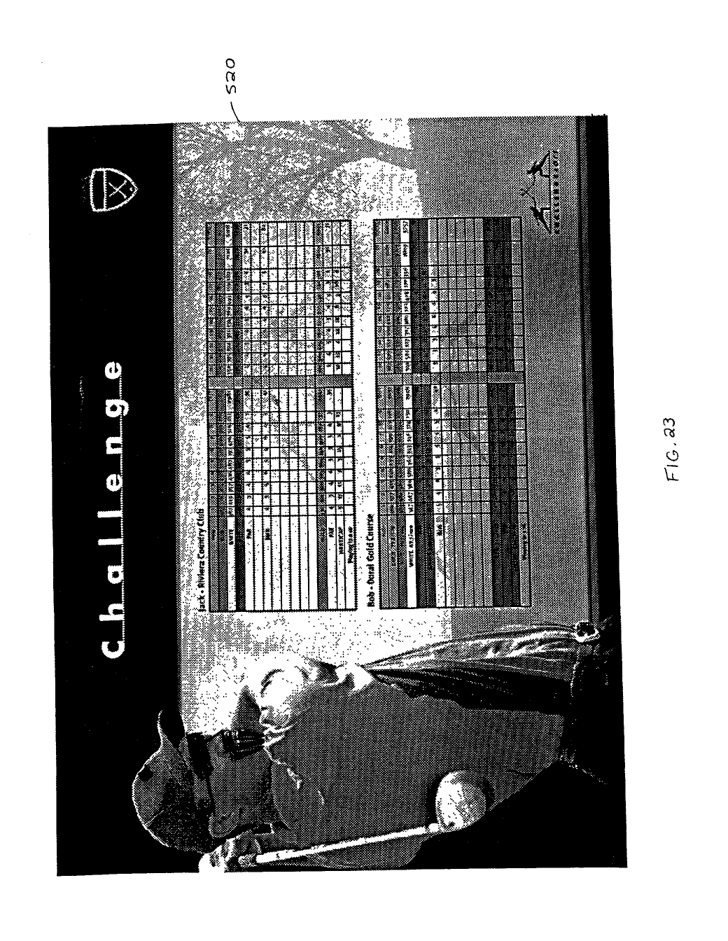

Once Jack's scorecard is submitted, the system may determine whether his opponent, Bob, has submitted his scorecard. If not, display screen 500 in FIG. 21 may show a message saying, “Bob has not submitted his scorecard for a challenge. He has 12 days to do so.” The number of days left may be the time remaining from the time that the challenge was made and the time limit that was set. This message may be immediately shown on display screen 500 or may be an e-mail message sent to Jack. Concurrently, Bob may receive a message, either via e-mail or on display screen 502 shown in FIG. 22, with the following message: “Bob—Jack has submitted his scorecard. Have you completed your round yet? You have 12 days to do so.”

If one of the opponents is a professional golfer, there may be no need to submit the scorecard to the other player, no need to wait for the other player to submit a scorecard, and no need to email the pro. For a pro, his or her golf results may already be stored in the system. These results may be from any suitable round of golf for which data is available, and may be updated each time the pro plays a round of golf in a championship, for leisure, or at any other time.

Because professional golfers may have a handicap that is “scratch,” par, or zero, while in reality the golfers consistently score below par, these golfers may be assigned a negative handicap by the invention. In such cases, strokes would be added to the professional golfers' holes instead of being subtracted as described above. In this way, the average golfer can compete with the professional.

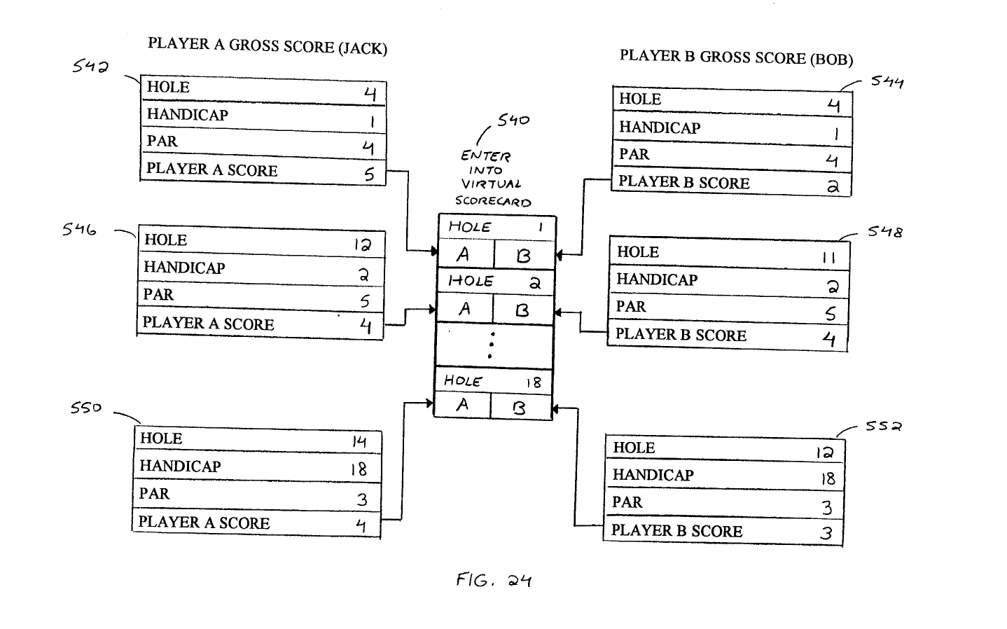

Once both players Bob and Jack have completed their respective rounds of golf and submitted their scores in the starter's shack, a display screen 520 may be shown in FIG. 23 showing each player's scorecard with results. The results may be the adjusted gross score (without handicap strokes) or net score (with handicap strokes). Meanwhile, the system may create a virtual scorecard.

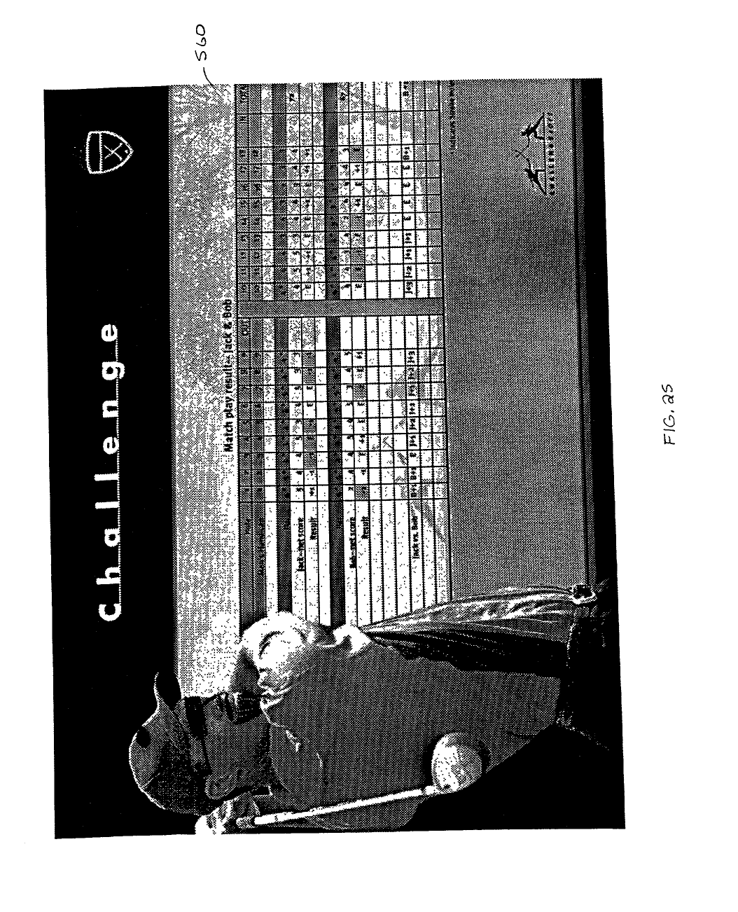

FIG. 24 illustrates how each player's scores may be entered into the virtual scorecard 540. Based on Jack's scorecard from FIG. 16 and Bob's scorecard from FIG. 17, the handicap holes from each scorecard may first be lined up in the virtual scorecard. In this example, handicap hole 1 is hole four for both Jack 542 and Bob 544. Jack's net score at hole 4 (542) and Bob's net score at hole 4 (544) are entered into virtual scorecard 540 as hole 1. Handicap hole 2 is hole 12 for Jack 546, which becomes hole 2 for virtual scorecard 540. For Bob, hole 2 on virtual scorecard 540 is hole 11 548. Holes 1 to 18 on virtual scorecard 540 may then be created from scores on handicap holes 1 to 18, respectively, on each of Jack and Bob's scorecard. The scores that are entered into virtual scorecard 540 may be the scores that include the handicap strokes where applicable (or net score). Finally, virtual scorecard 540 hole 18 is hole 14 for Jack 550 and hole 12 for Bob 552. Once the virtual scorecard is generated, the winner of the golf game may be determined based on the competitive format selected.

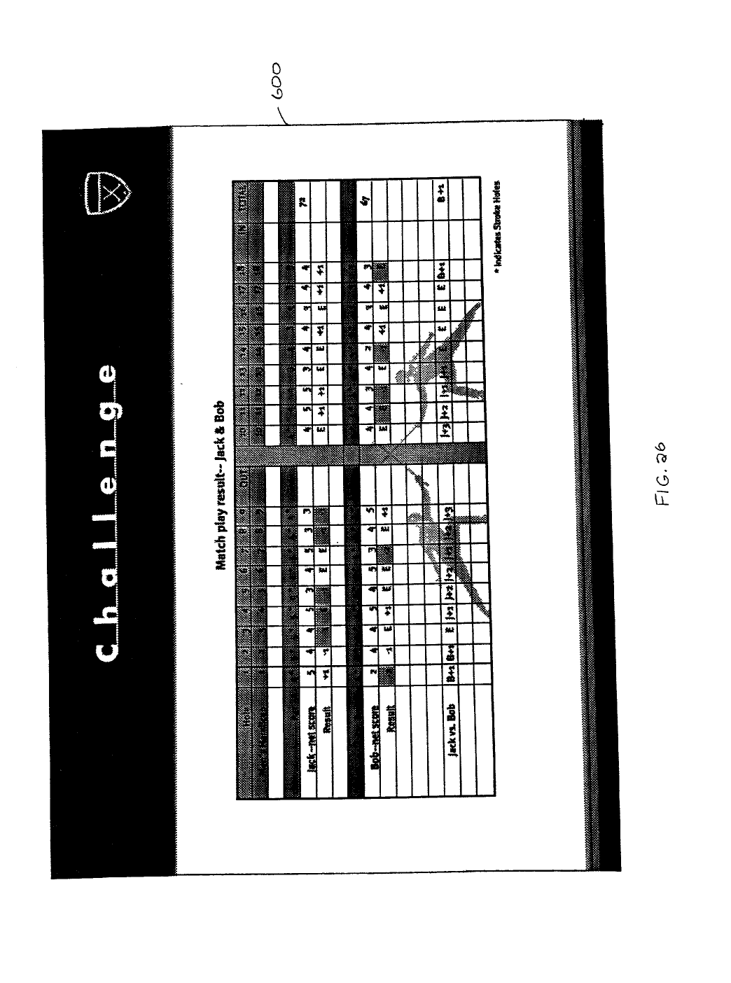

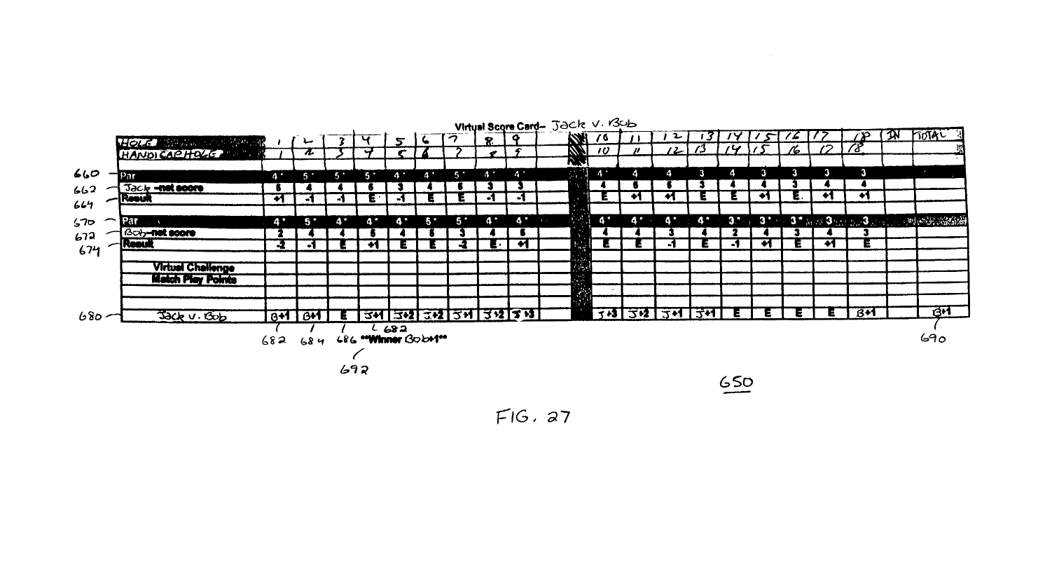

FIGS. 25-26 illustrate different displays of virtual scorecard results between Jack and Bob. FIG. 25 may show an initial display screen of the golf results 560. A player may click on the scorecard to view a larger image size as illustrated in display 600 of FIG. 26.

FIG. 27 illustrates the virtual scorecard results 650 for a match play. The par on Jack's course 660 and on Bob's course 670 are listed for each hole of virtual scorecard holes 1 to 18. Jack's net score 662 and Bob's net score 672 are also listed along with the results relative to par 664 and 674, respectively. A result of “+1,” “+2,” etc. indicates that a player shot one, two, etc. stroke(s) over par. A result of “E” indicates that a player shot a par. A result of “−1,” “−2,” or “−3” indicates that a player shot one, two, or three stroke(s) under par. Along the bottom of scorecard 650 is the match play results after each hole. The winner of each hole earns a point and the points are tallied. For example, Bob won the first hole, designated by “B+1” 682. At hole two, there was a tie so the current tally remains at “B+1” 684. Jack won the third hole so the tally is “E” (to indicate a zero or even score) 686. Jack won the fourth hole so the tally is now “J+1” 682, and so on for the remaining holes. In the rightmost or total column, the result is “B+1” 690 to indicate that Bob is the winner by one hole 692.

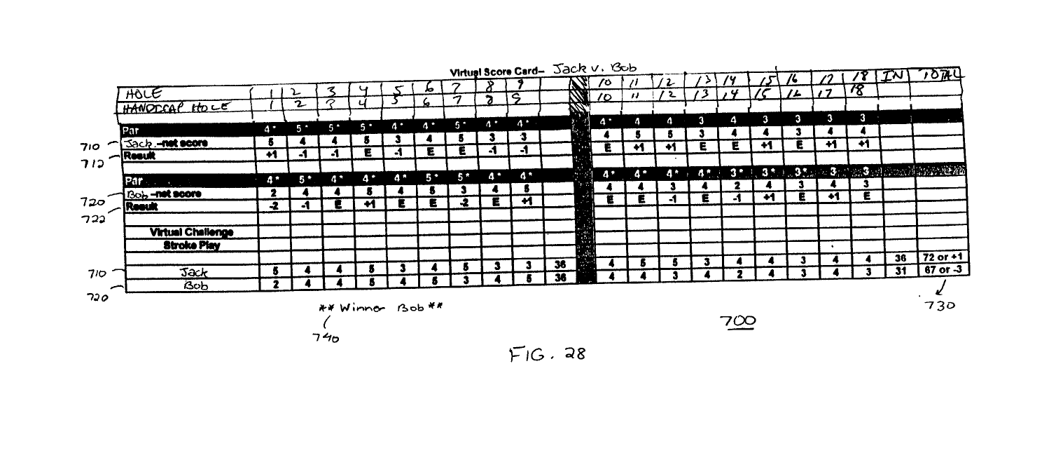

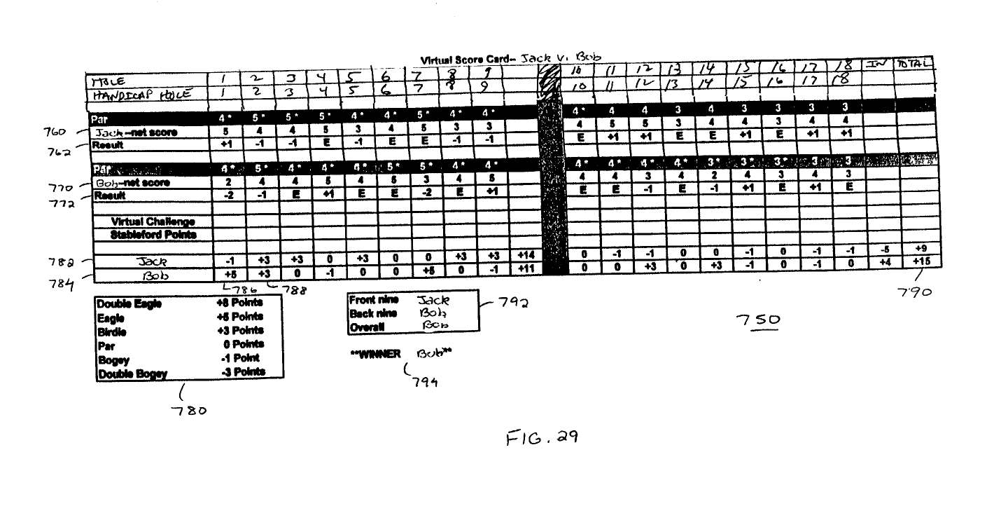

FIG. 28 illustrates the virtual scorecard results 700 for a stroke play. Jack's net score 710 and results 712 (based on the par) are displayed on virtual scorecard 700 along with Bob's net score 720 and results 722. The total number of strokes for all eighteen holes or the results based on the par are tallied for a total net score or net results 730. The winner is Bob 740 by four strokes.

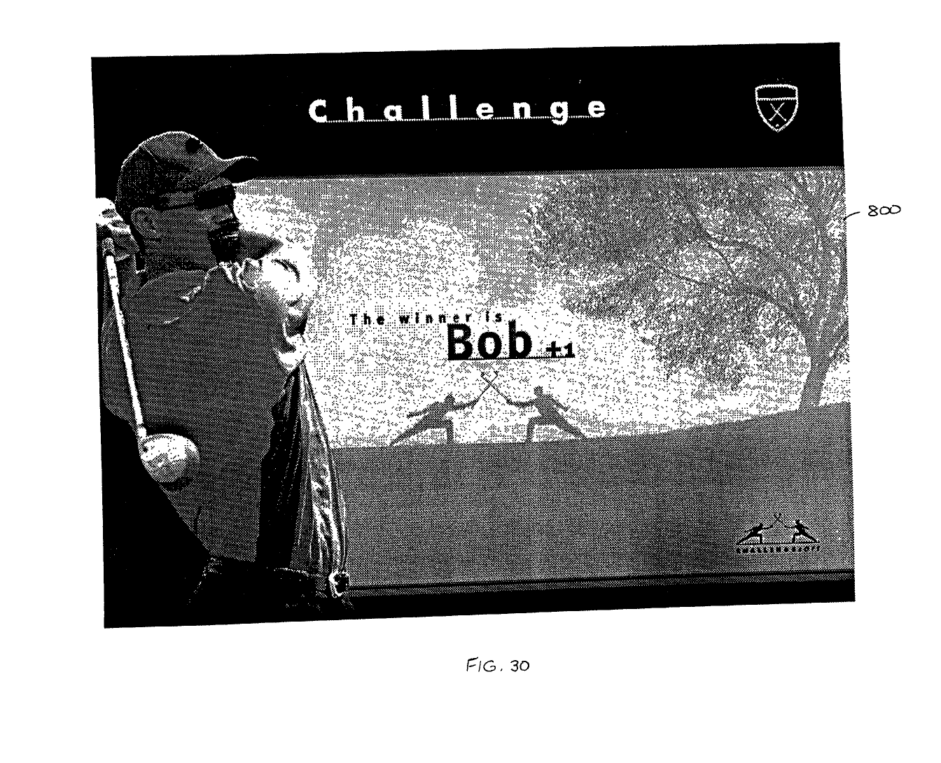

FIG. 29 illustrates the virtual scorecard results 750 for stableford play. Jack's net score 760 and results 762 are displayed on virtual scorecard 750 along with Bob's net score 770 and results 772. In stableford, the performance at each hole is assigned points. In point assignment chart 780, a double eagle (3 under par or −3) is assigned eight points, an eagle (2 under par or −2) is five points, a birdie (1 under par or −1) is three points, a par zero points, a bogey (1 over par or +1) is minus one point, a double bogey (2 over par or +2) is minus two points, etc. For virtual scorecard hole 1 786, Jack scored a bogey and is awarded minus one point while Bob scored an eagle and is awarded five points. At hole 2, Jack and Bob both scored a birdie and are both awarded three points 788. The total points at each hole are summed to produce the results 790. The scores may be broken down by the first nine holes and the last nine holes. As shown in results table 792, Jack won the first nine holes, Bob won the back nine, and overall, Bob is the winner by six points 794.

While game results may be combined on a single virtual scorecard, the invention may calculate similar competitive results without creating a virtual scorecard.

Competitive results, similarly, could be calculated in a number of different ways, including a simple comparison of at least two but any number of golf scorecards to determine the winner of a previously determined selection of golfers in a golf match.

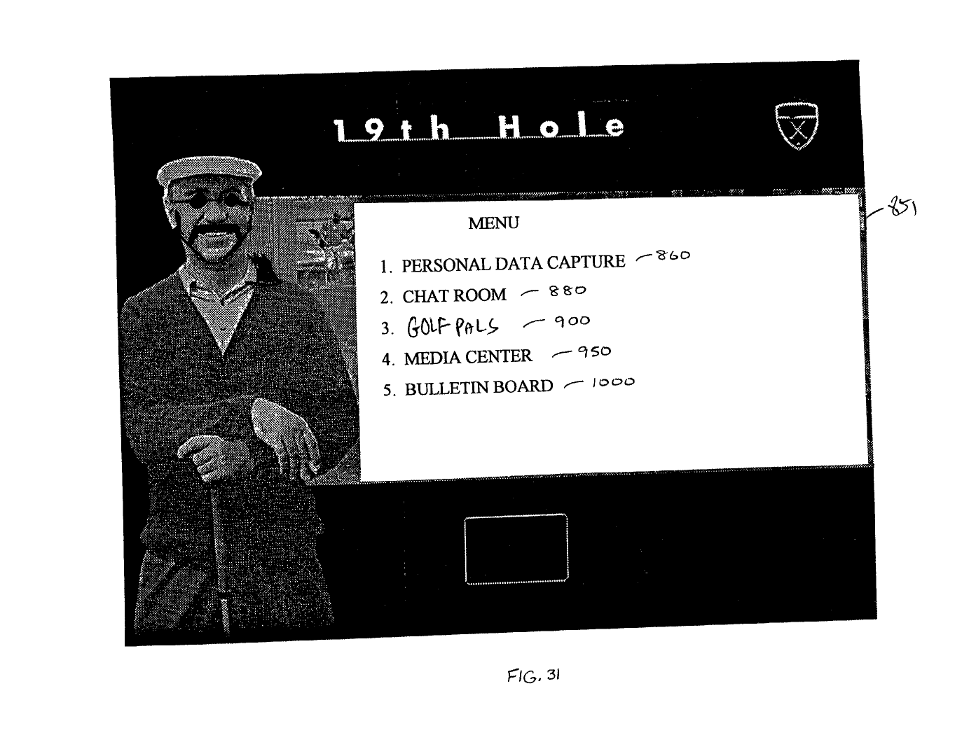

Once the winner is determined, the results may be displayed to the players as illustrated in FIG. 30. A display screen 800 shows that Bob is the winner from a match play by one hole. The results may be displayed immediately to the player and/or the results may be e-mailed to all players involved. Individual win and loss records may be updated, which may keep track of player information, such as player performance and handicaps.

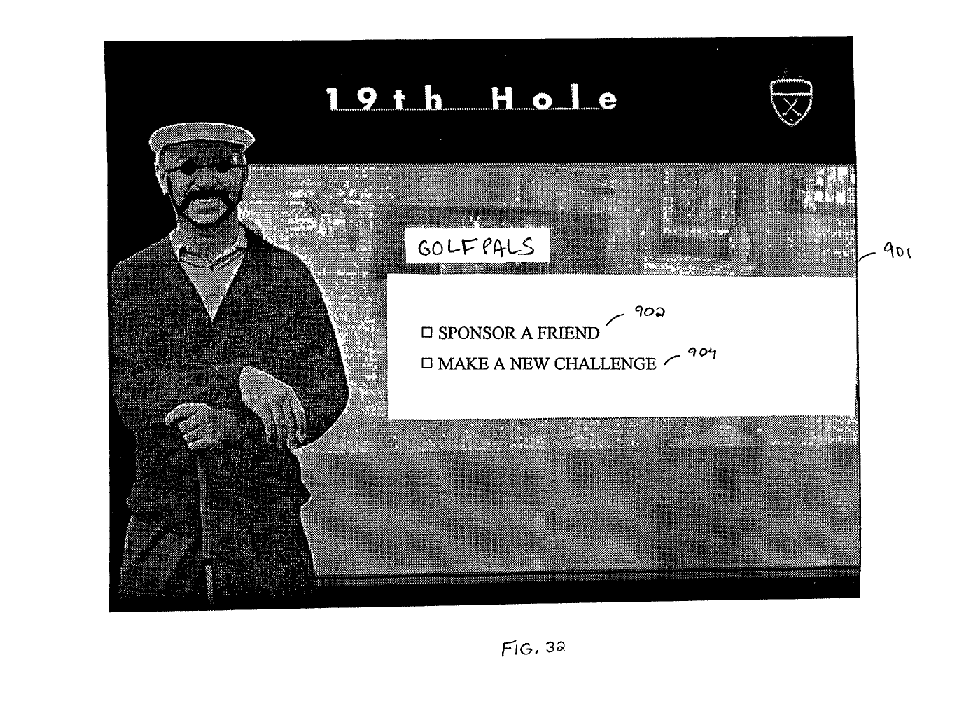

FIG. 31 illustrates a 19^{th} Hole or clubhouse menu that may be displayed when a player selects “19^{th} Hole” option 850 from main menu 60 (FIG. 2) or enters the 19^{th} Hole after completing a round of golf on-line (e.g., submitting a scorecard). Display screen 851 may display a menu containing the following options: “1. Personal Data Capture” option 860, “2. Chat Room” option 880, “3. Golf Pals” option 900, “4. Media Center” option 950, or “5. Bulletin Board” option 1000. Similar to the main menu described in FIG. 2, these options may be selected using any suitable approach.

“Personal Data Capture” option 851 from menu 850 (FIG. 31) may allow a player to view personal data. This data may include results from various golf challenges, handicaps calculated during each golf challenge, his or her performance compared to other registered players on the system, frequency of playing and accessing the 19^{th} hole, archived rounds of golf, and any other suitable data.

“Chat Room” option 880 from menu 851 (FIG. 31) may allow a player to enter various chat rooms. Here, a player may communicate with his or her opponent to comment on the game, chat with other players about golf or any other topic, or even chat with professionals.

“Golf Pals” option 900 from menu 851 (FIG. 31) may allow a player to add a golf pal or create a new challenge. As illustrated in a display screen 901 of FIG. 32, a player may select to sponsor a friend 902 or make a new challenge 904.

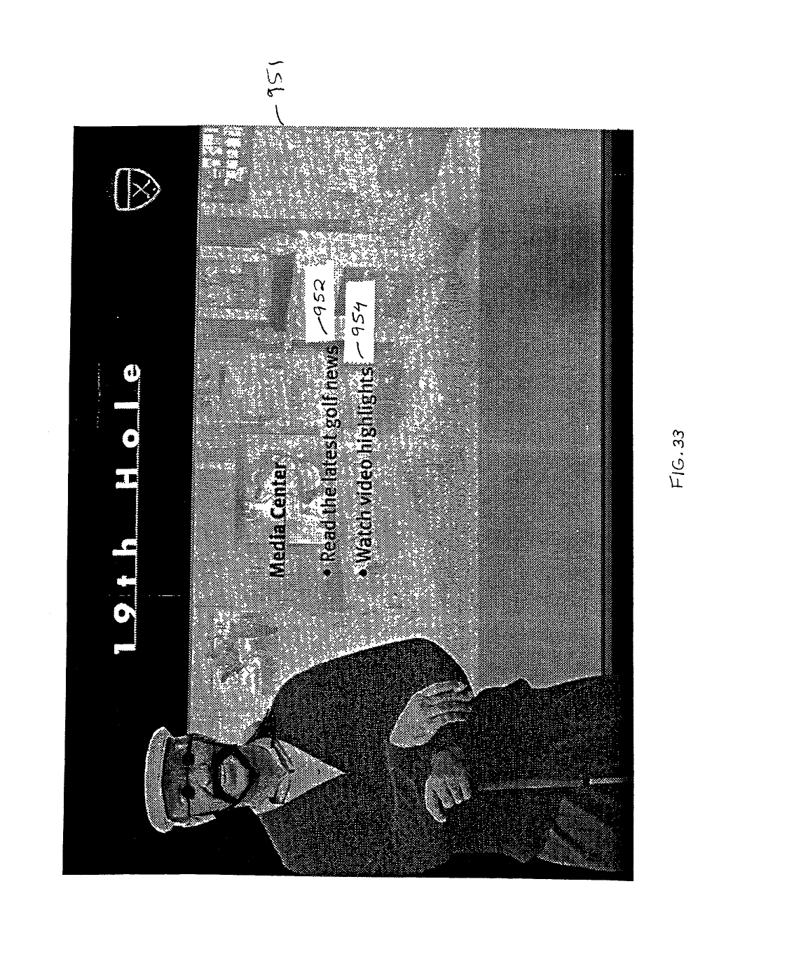

“Media Center” option 950 from menu 851 (FIG. 31) may allow a player to read or view golf-related information. As illustrated in a display screen 951 of FIG. 33, a player may read the latest golf news 952 or watch golf-related video highlights 954.

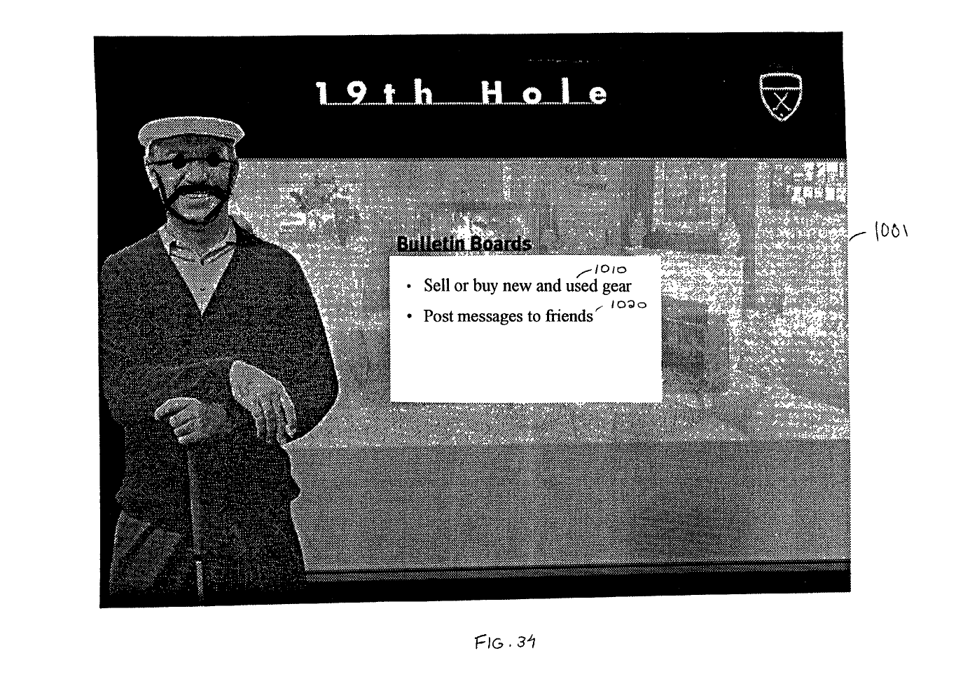

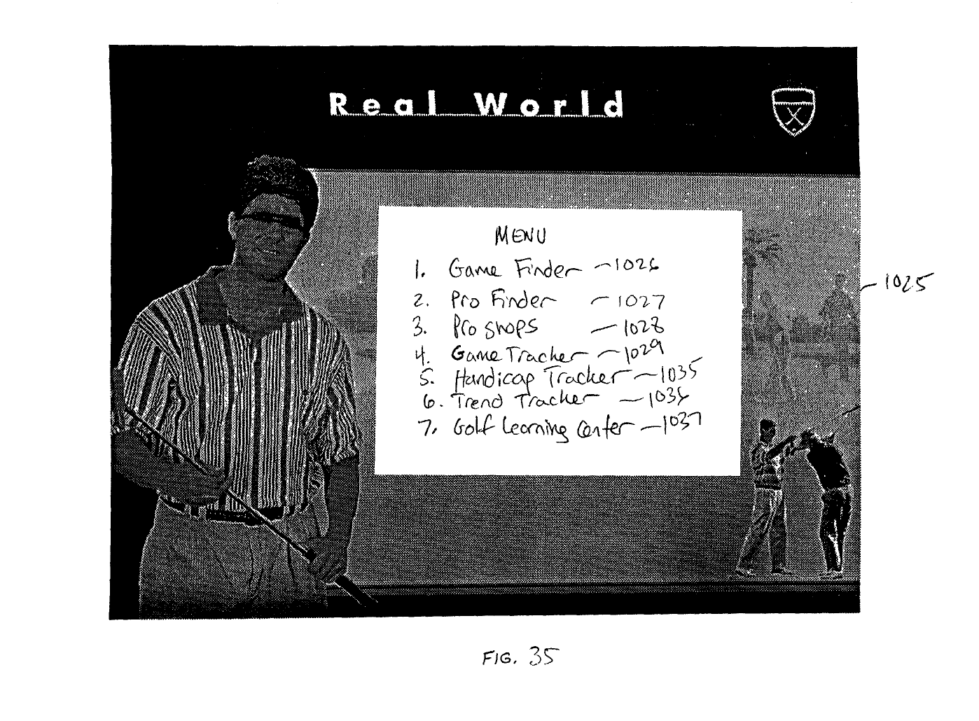

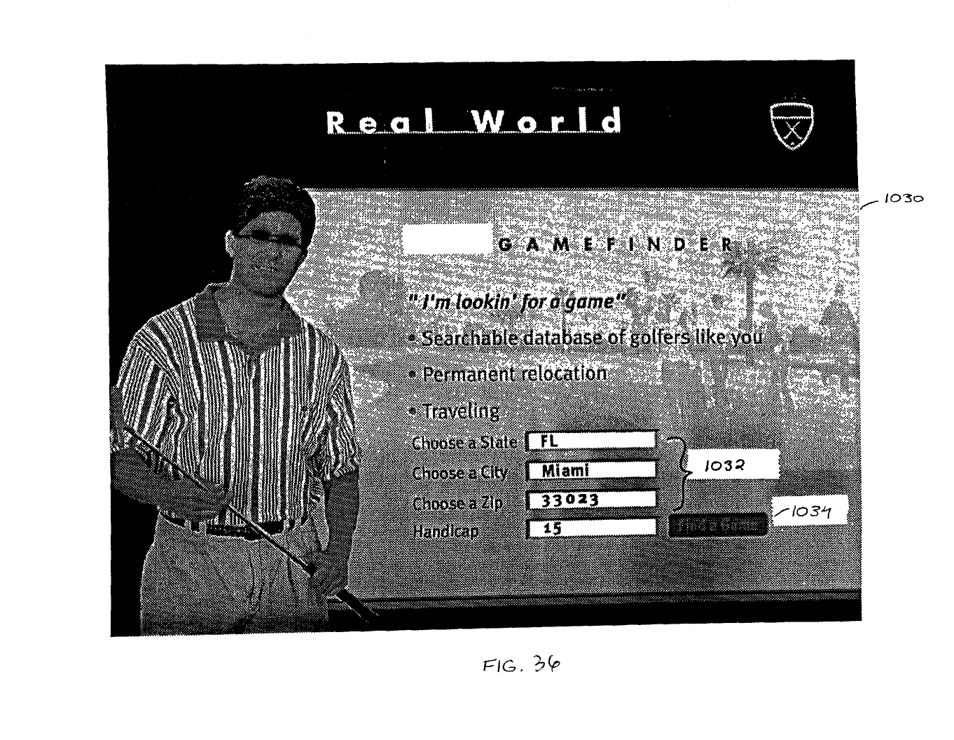

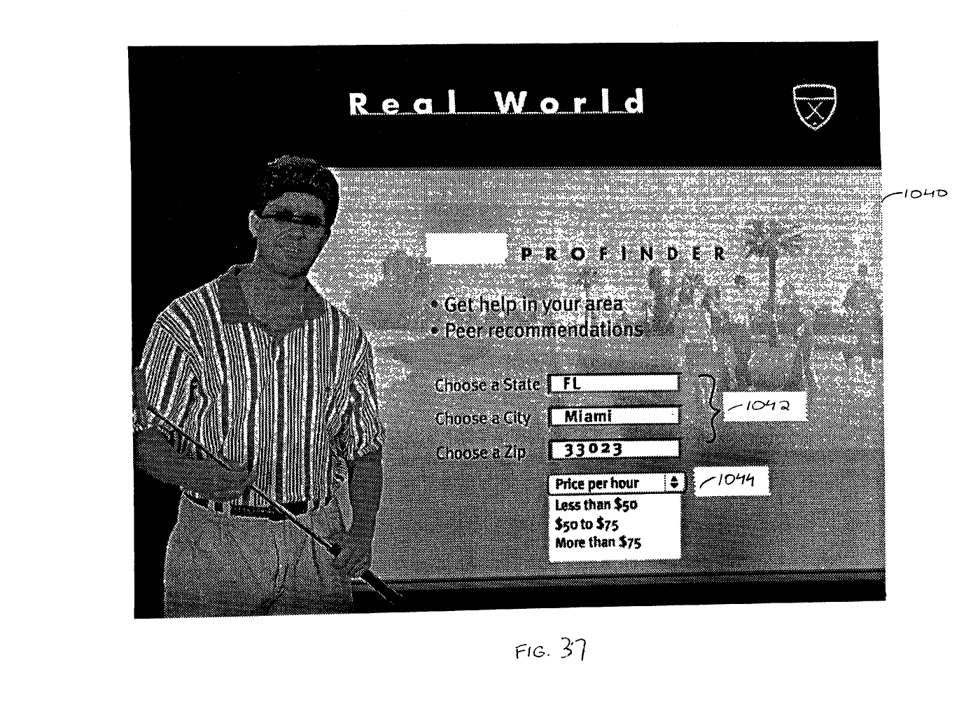

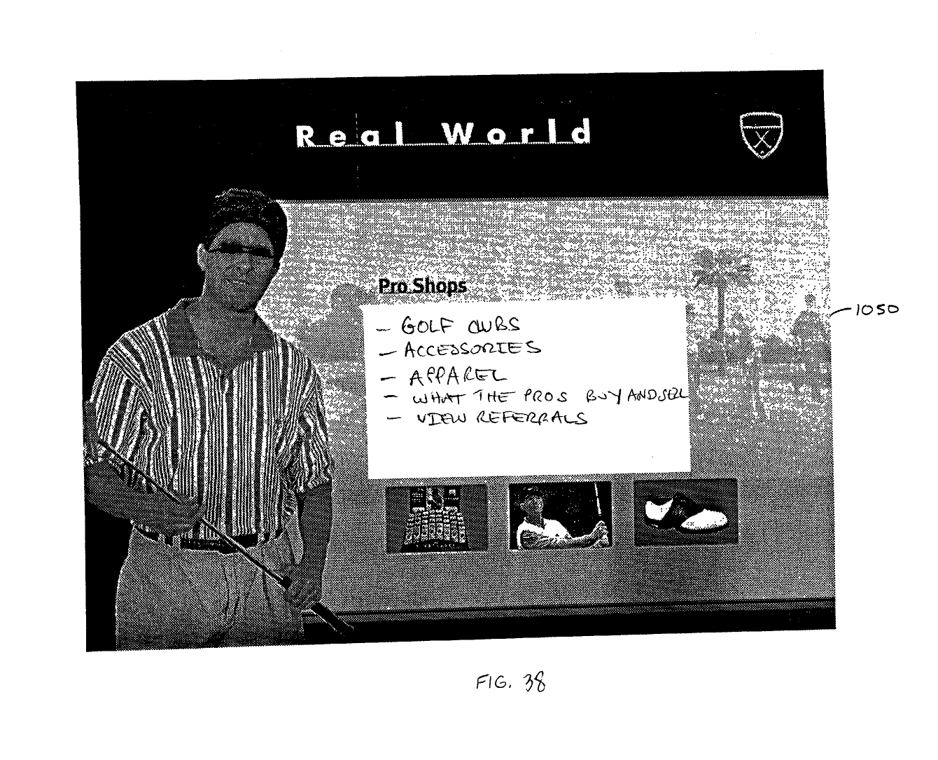

“Bulletin Board” option 1000 from menu 851 (FIG. 31) allows a player to read and post notes. As illustrated in a display screen 1001 of FIG. 34, a player may view or post notices to sell or buy new and used gear 1010, post messages to friends 1020, etc.

FIG. 35 illustrates a “Real World” menu that may be displayed when a player selects “Real World” option 855 from main menu 60 (FIG. 2). Display screen 1025 may display a menu containing the following options: “1. Game Finder” option 1026, “2. Pro Finder” option 1027, “3. Pro Shops” option 1028, “4. Game Tracker” option 1029, “5. Handicap Tracker” option 1035, “6. Trend Tracker” option 1036, and “7. Golf Learning Center” option 1037. Similar to the main menu described in FIG. 2, these options may be selected using any suitable approach.

FIG. 36 illustrates the link to a game finder tool that may be displayed on a display screen 1030. This tool may provide a golfer with possible golf opponents for the golfer to play against and may suggest golf courses for the golfer to play on. The golfer may be able to view past scorecards and handicaps of possible opponents. This may be particularly useful for golfers who are relocating or who are traveling. The player may need to enter in information 1032 such as state, city, zip code, and handicap. Other information may include age, sex, personality type, race, price range of golf course, time availability, etc. Once the information is entered, the player may press “Find A Game” button 1034. A list of possible players with contact information (e.g., e-mail address, telephone number, etc.), golf course information (e.g., name, address, telephone number, available tee times, etc.), and any other suitable information, such as comments from previous opponents, may appear on another screen.

FIG. 37 illustrates the link to a pro finder tool that may be displayed on a display screen 1040. This tool may provide a player with information regarding professional instructors in a particular area. The player may enter in information 1042 such as the state, city, and zip code of the player, and the price range 1044 that the player is willing to pay for golf lessons. Once the data is entered, a listing of professional instructors in the area may be displayed along with his or her experience, peer recommendations, contact information, and any other suitable information. This tool may also enable pros to find students, based upon state, city, zip code, handicap and/or any other suitable factor.

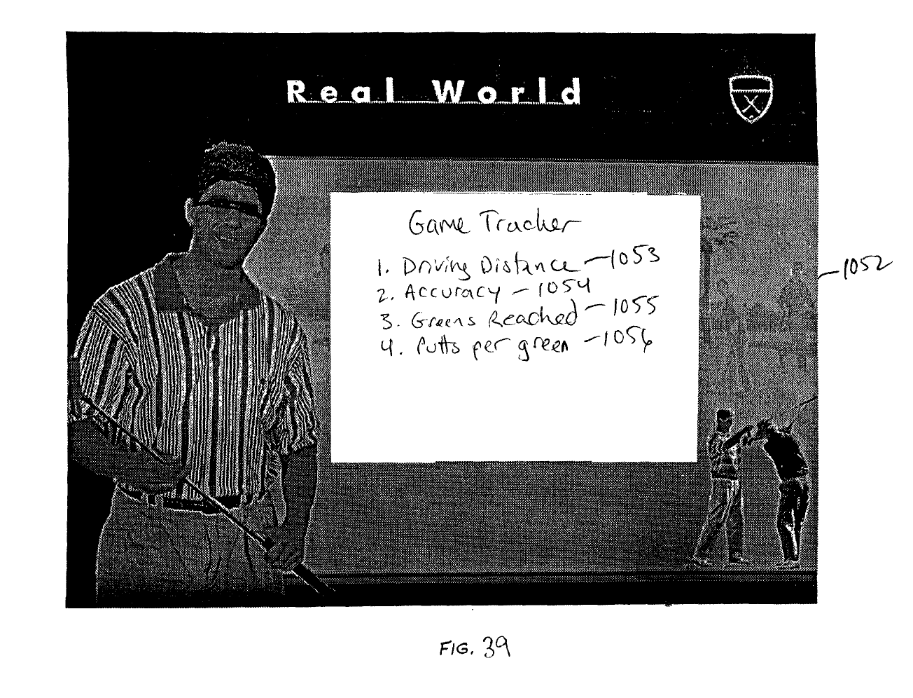

Upon selecting “Pro Shops” option 1028 from menu 1025 (FIG. 35), a display 1050 that provides a player with an opportunity to shop for golf gear may be displayed. As illustrated in a display screen 1050 of FIG. 38, a player may view an on-line catalog for particular brand golf clubs, accessories, apparel, and any other golf-related items, view what professionals buy and or sell, view referrals, and any other suitable information.

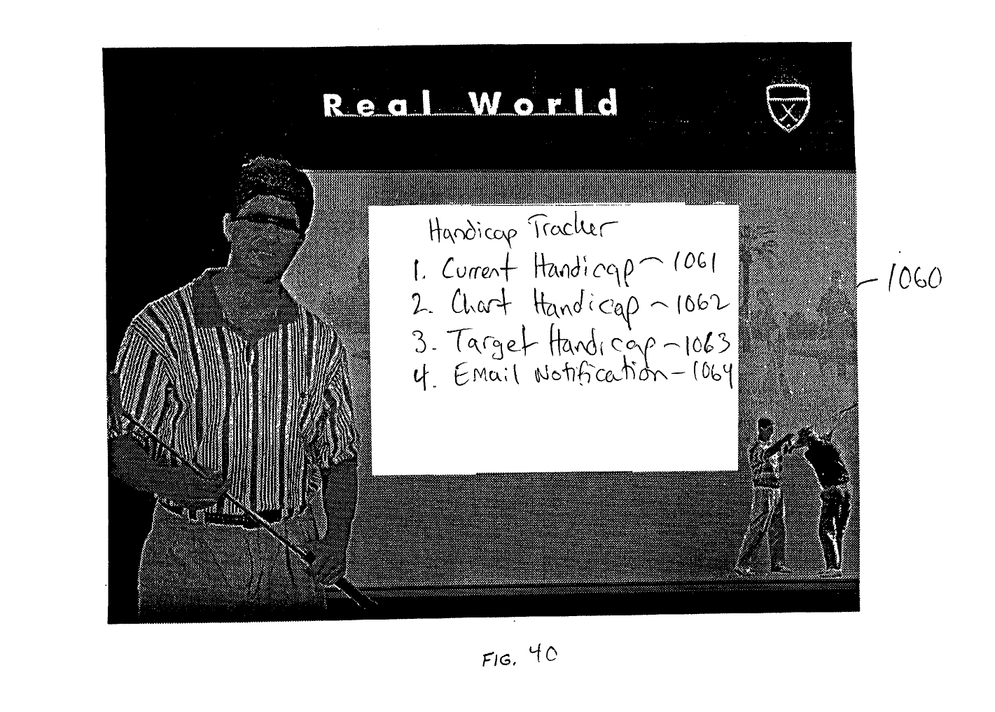

Upon selecting “Game Tracker” option 1029 from menu 851 (FIG. 35), a game tracker tool may be provided to the player to view various statistics of his or her game. For example, as shown in display 1052 of FIG. 39, a player may be able to see driving distance statistics, accuracy statistics, greens reached statistics, putts per green statistics by selecting options 1053, 1054, 1055, and 1056, respectively. Any other suitable statistics may be provided. These statistics may be provided in table form, graphical form, or in any other suitable form. In order for these statistics to be available suitable data may be required from the player. For example, when using a golf-cart-based computer scoring system, data relating to the position of the ball at each stroke may be used to provide the statistics provide by the game tracker tool.

The data presented in the game tracker tool may only be viewable by the player corresponding to the data, by any registered user, by pros, by the operator of the system of the invention, etc. This data may also be used to provide awards or other recognition periodically for outstanding game performance.

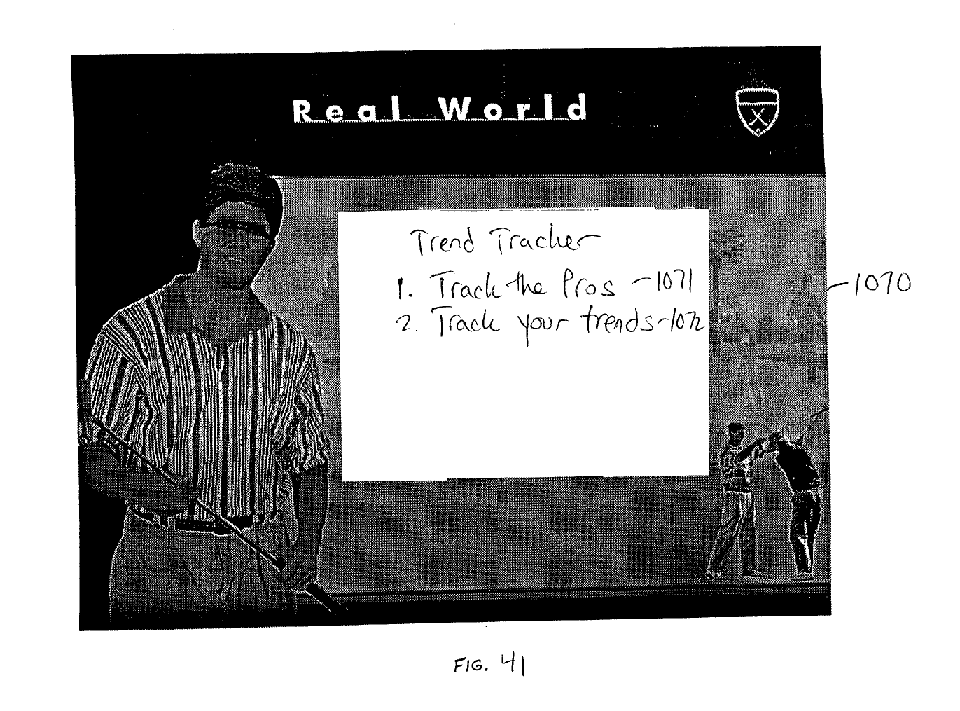

Upon selecting “Handicap Tracker” option 1035 from menu 851 (FIG. 35), a handicap tracker tool may be provided to the player to view information relating to his or her handicap. For example, as shown in display 1060 of FIG. 40, a player may be able to see his or her current handicap (which is update continually based upon scores submitted to the system), a chart of his or her handicap over a specified period of time, and what scores need to be achieved to reach a target handicap by selecting options 1061, 1062, and 1063, respectively. Any other suitable information may be provided. By selecting option 1064, a player may configure email notifications regarding the player's handicap. These notifications may congratulate the player when the player's handicap has decreased, or offer the player instruction when the player's handicap has increased.

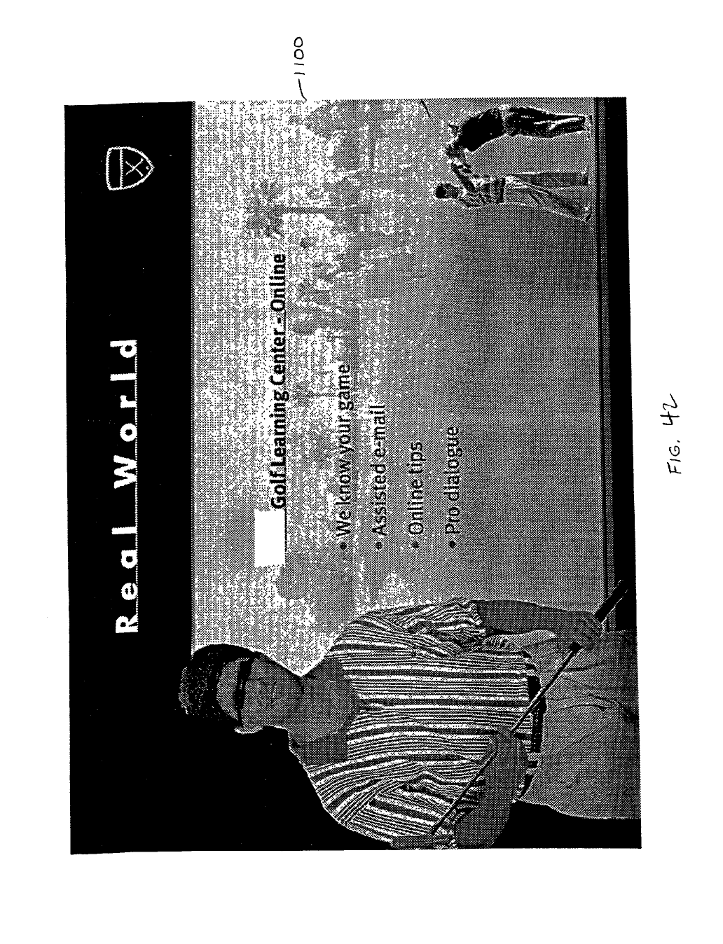

Upon selecting “Trend Tracker” option 1036 from menu 851 (FIG. 35), a trend tracker tool may be provided to the player to view trend information relating to the golf game of the pros and of himself or herself. For example, as shown in display 1070 of FIG. 41, a player may be able to see trends of pros and of him or herself by selecting options 1071 and 1072, respectively. These trends may indicate over all game performance of the player over a period of time. Any other suitable information may be provided.

Upon selecting “Golf Learning Center” option 1037 from menu 851 (FIG. 35), various options which provide golf help may be presented to the player. As illustrated in display 1100 of FIG. 42, a player may e-mail instructors, browse through on-line golf tips provided by instructors, or engage in pro dialogue in a chat room, for example. Because the player's data may be stored in the system, instructors may have access to this information in order to be able to provide more useful advice or tips.

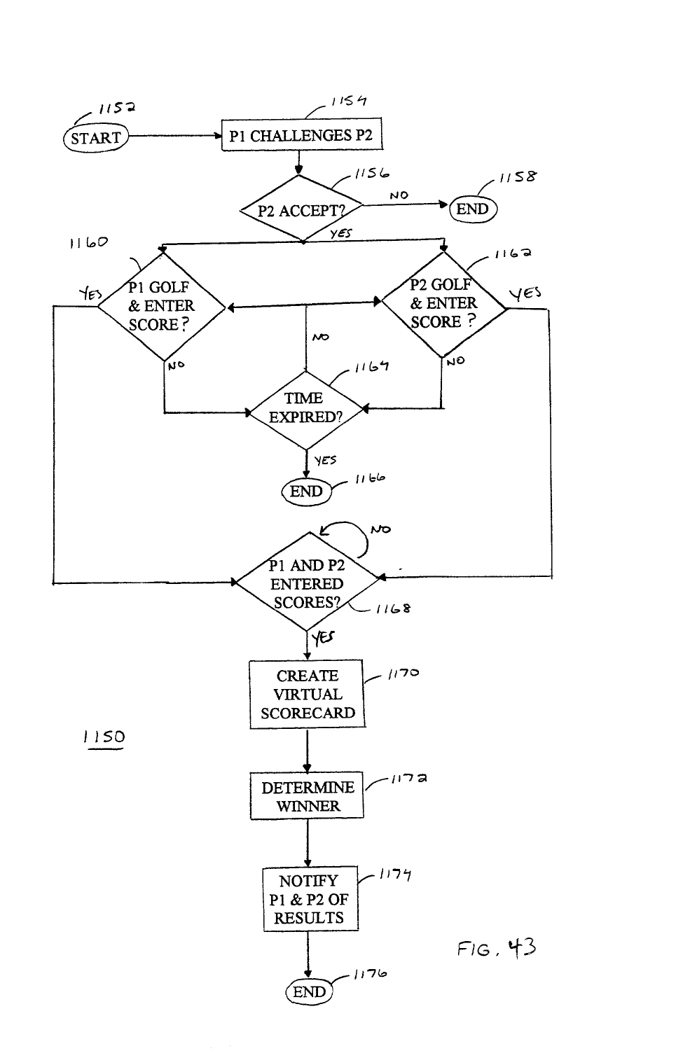

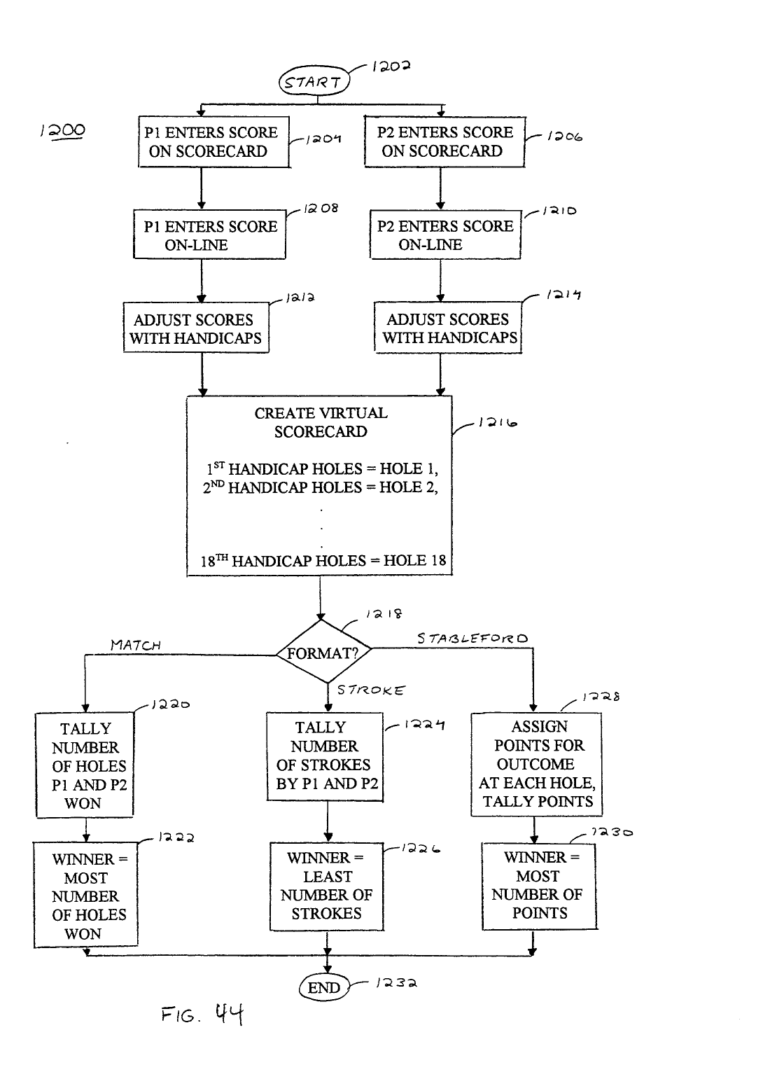

FIG. 43 illustrates a flow diagram of one embodiment of a challenge process 1150. Process 1150 begins at step 1152 with a first player P1. At step 1154, P1 challenges a second player P2. At step 1156, the process determines whether P2 has accepted the challenge. If P2 denied the challenge, process 1150 ends at step 1158. If P2 accepts the challenge, process 1150 moves to step 1160 where the process determines whether P1 has played his or her round of golf and entered his or her score. At the same time, process 1150 also moves to step 1162 where the process determines whether P2 has played his or her round of golf and entered his or her score. If neither P1 nor P2 have entered their scores, process 1150 moves to step 1164 where the process determines if the time limit has expired. If the time has expired, the process ends at step 1166. If time has not expired, the process moves backs to steps 1160 and 1162. If however, either P1 or P2 or both have entered a score, process 1150 moves to step 1168. Here, the process determines if both P1 and P2 have entered their scores. If both have not, the process remains in 1168 until either both players have entered their scores before time has expired. If both players have entered their scores, process 1150 moves to step 1170 where a virtual scorecard is created. Next, the winner is determined at step 1172. Once a winner is determined, process 1150 moves to step 1174 where P1 and P2 are notified of the results and the process ends at step 1176.

FIG. 44 illustrates a flow diagram of one embodiment of a scorecard generation process 1200. Process 1200 begins at step 1202 with a challenge between a first player P1 and a second player P2. At steps 1204 and 1206, P1 and P2, respectively, play a round of golf and enter their scores at each hole on a scorecard. Next, P1 and P2, at steps 1208 and 1210, respectively, enter their scores on-line. Once P1 and P2 have entered their scores, process 1200 moves to step 1212 and 1214, respectively, where each player's net score is computed by calculating the virtual handicap and adjusting the score to account for the handicap strokes. Process 1200 then moves to step 1216 where the virtual scorecard is created. The first handicap holes for P1 and P2 become the first hole on the virtual scorecard, the second handicap holes for P1 and P2 become the second hole on the virtual scorecard, etc.

At step 1218, the competitive format is determined, which was selected during the making of the challenge. If match play was selected, the process moves to step 1220 where the winner of each hole is determined by the player with the least number of strokes relative to par. At step 1222, the winner is determined by the player who won the most number of holes and the process ends at step 1232. If stroke play was selected, the process moves to step 1224 where the process tallies the total number of strokes for the eighteen holes for each P1 and P2. At step 1226, the winner is the player with the least number of strokes relative to par and the process ends at step 1232. If stableford play was selected, the process moves to step 1228 where a designated number of points are assigned for the type of performance at each hole (e.g., double eagle, eagle, birdie, par, bogey, double bogey), and the points are tallied for each player. At step 1230, the winner is the player with the most number of points and the process ends at step 1232.

Thus it is seen that systems and methods for a virtual scorecard are presented to enable two players to compete in a round of golf from anywhere at any time. One skilled in the art will appreciate that the present invention can be practiced by other than the described embodiments, which are presented for purposes of illustration and not of limitation, and the present invention is limited only by the claims which follow.

What is claimed is:

1. A method for providing a virtual match between at least a first player and a second player, comprising:
receiving a first plurality of scores corresponding to play of a first player on a first plurality of golf holes;
receiving a second plurality of scores corresponding to play of a second player on a second plurality of golf holes;
pairing one of the first plurality of scores corresponding to one of the first plurality of golf holes with one of the second plurality of scores corresponding to one of the second plurality of golf holes based upon a difficulty level of the one of the first plurality of golf holes and a difficulty level of the one of the second plurality of golf holes; and
comparing the play of the first player to the play of the second player based upon the pairing of the one of the first plurality of scores with the one of the second plurality of scores.

2. The method of claim 1, further comprising enabling the first player to indicate that the first player wants to enter into the virtual match against the second player.

3. The method of claim 2, further comprising enabling the first player to indicate the second player as being at least one of a person from a golf pals list, a professional golfer, and a team of golfers.

4. The method of claim 1, further comprising enabling the second player to indicate that the second player is willing to enter into the virtual match against the first player.

5. The method of claim 1, further comprising receiving a selection of a competitive format.

6. The method of claim 1, wherein the selection of the competitive format is one of match play, stroke play, and stableford play.

7. The method of claim 5, further comprising determining a winner based on the selection of the competitive format.

8. The method of claim 1, further comprising monitoring whether at least one of the first player and the second player completes the corresponding play within a given period of time.

9. The method of claim 8, further comprising requiring receipt of the corresponding plurality of scores within the given period of time.

10. The method of claim 1, further comprising enabling at least one of the first player and the second player to enter the corresponding plurality of scores manually.

11. The method of claim 1, further comprising receiving at least one of the first plurality of scores and the second plurality of scores automatically.

12. The method of claim 1, further comprising summing at least one of the first plurality of scores and the second plurality of scores to produce a gross score.

13. The method of claim 12, further comprising using the gross score to calculate a new handicap score.

14. The method of claim 1, further comprising adjusting at least one of the first plurality of scores and the second plurality of scores to account for a handicap of one of the first player and the second player.

15. The method of claim 1, wherein the pairing of the one of the first plurality of scores with the one of the second plurality of scores is based upon a handicap hole number assigned to the one of the first plurality of scores and a handicap hole number assigned to the one of the second plurality of scores.

16. The method of claim 1, further comprising presenting a virtual scorecard based upon the pairing of the one of the first plurality of scores and the one of the second plurality of scores.

17. The method of claim 1, further comprising determining which of the first player and the second player is a winner of the virtual match.

18. The method of claim 1, further comprising notifying the first player and the second player of which is the winner of the virtual match.

19. A system for providing a virtual match between at least a first player and a second player, comprising:
a communication network that receives a first plurality of scores corresponding to play of a first player on a first plurality of golf holes, and that receives a second plurality of scores corresponding to play of a second player on a second plurality of golf holes; and
a processor that pairs one of the first plurality of scores corresponding to one of the first plurality of golf holes with one of the second plurality of scores corresponding to one of the second plurality of golf holes based upon a difficulty level of the one of the first plurality of golf holes and a difficulty level of the one of the second plurality of golf holes, and that compares the play of the first player to the play of the second player based upon the pairing of the one of the first plurality of scores with the one of the second plurality of scores.

20. The system of claim 19, wherein the processor also enables the first player to indicate that the first player wants to enter into the virtual match against the second player.

21. The system of claim 20, wherein the processor also enables the first player to indicate the second player as being at least one of a person from a golf pals list, a professional golfer, and a team of golfers.

22. The system of claim 19, wherein the processor also enables the second player to indicate that the second player is willing to enter into the virtual match against the first player.

23. The system of claim 19, wherein the processor also receives a selection of a competitive format.

24. The system of claim 19, wherein the selection of the competitive format is one of match play, stroke play, and stableford play.

25. The system of claim 24, wherein the processor also determines a winner based on the selection of the competitive format.

26. The system of claim 19, wherein the processor also monitors whether at least one of the first player and the second player completes the corresponding play within a given period of time.

27. The system of claim 26, wherein the processor also requires receipt of the corresponding plurality of scores within the given period of time.

28. The system of claim 19, wherein the processor also enables at least one of the first player and the second player to enter the corresponding plurality of scores manually.

29. The system of claim 19, wherein the processor also receiving at least one of the first plurality of scores and the second plurality of scores automatically.

30. The system of claim 19, wherein the processor also sums at least one of the first plurality of scores and the second plurality of scores to produce a gross score.

31. The system of claim 30, wherein the processor also uses the gross score to calculate a new handicap score.

32. The system of claim 19, wherein the processor also adjusts at least one of the first plurality of scores and the second plurality of scores to account for a handicap of one of the first player and the second player.

33. The system of claim 19, wherein the pairing of the one of the first plurality of scores with the one of the second plurality of scores is based upon a handicap hole number assigned to the one of the first plurality of scores and a handicap hole number assigned to the one of the second plurality of scores.

34. The system of claim 19, wherein the processor also presents a virtual scorecard based upon the pairing of the one of the first plurality of scores and the one of the second plurality of scores.

35. The system of claim 19, wherein the processor also determines which of the first player and the second player is a winner of the virtual match.

36. The system of claim 19, wherein the processor also notifies the first player and the second player of which is the winner of the virtual match.
